(19) United States
(12) Patent Application Publication
(10) Pub. No.: US 2021/0308499 A1
(43) Pub. Date: Oct. 7, 2021

(54) POWERED AIR-PURIFYING RESPIRATOR

(71) Applicant: WHIRLPOOL CORPORATION, Benton Harbor, MI (US)

(72) Inventors: Alberto Regio GOMES, St. Joseph, MI (US); Paul B. ALLARD, Coloma, MI (US); Brent M. BURGESS, Edwardsburg, MI (US); Marcus R. FISCHER, Stevensville, MI (US); Jordan M. GRIDER, Farmington Hills, MI (US); Christopher A. JONES, St. Joseph, MI (US); Abhay NAIK, Stevensville, MI (US); Arun RAJENDRAN, St. Joseph, MI (US)

(21) Appl. No.: 17/219,420

(22) Filed: Mar. 31, 2021

Related U.S. Application Data
(60) Provisional application No. 63/005,921, filed on Apr. 6, 2020.
(60) Provisional application No. 63/012,721, filed on Apr. 20, 2020.

(51) Int. Cl. A62B 18/04; A42B 3/28; A62B 18/00

(52) U.S. Cl. CPC A62B 18/045; A62B 18/006; A62B 18/003; A42B 3/286

(57) ABSTRACT

An air purification system is provided. A visor portion is configured to secure to a head of a user and maintain a field of vision for the user. An air delivery portion is configured to draw in air from an external environment. A disposable barrier hood is configured to cover at least the visor portion. The visor portion defines a breathing outlet to exhaust the drawn-in air in proximity to a breathing area for consumption by the user. The disposable barrier hood fluidly isolates the breathing area from the external environment.

### CROSS-REFERENCE TO RELATED APPLICATIONS

This application claims the benefit of U.S. provisional application Ser. No. 63/005,921 filed Apr. 6, 2020, and U.S. provisional application Ser. No. 63/012,721 filed Apr. 20, 2020, the disclosures of which are hereby incorporated in their entireties by reference herein.

### TECHNICAL FIELD

This disclosure relates to the field of disposable protective face masks for use in isolating a user from an external environment during user activity. Several examples of devices within the scope of the present disclosure are provided.

### SUMMARY

In one or more illustrative examples, an air purification system is provided. A visor portion is configured to secure to a head of a user and maintain a field of vision for the user. An air delivery portion is configured to draw in air from an external environment. A disposable barrier hood is configured to cover at least the visor portion. The visor portion defines a breathing outlet to exhaust the drawn-in air in proximity to a breathing area for consumption by the user. The disposable barrier hood fluidly isolates the breathing area from the external environment.

In one or more illustrative examples, a method of using an air purification system is provided. Headgear is applied to a head of a user, the headgear including a visor portion for securing to the head of the user and maintaining a field of vision for the user and an air delivery portion for drawing in air from an external environment, the visor portion defines a breathing outlet to exhaust drawn-in air in proximity to a breathing area for consumption by the user. A barrier hood is installed over the headgear, the barrier hood covering at least the visor portion when installed for fluidly isolates the breathing area from the external environment. The air delivery portion is activated to urge the drawn-in air from the external environment through the breathing outlet.

### BRIEF DESCRIPTION OF THE DRAWINGS

FIG. 1 is a perspective view of a first step in applying a personal air purifying system according to a first example.

FIG. 2 is a perspective view of a second step in applying a personal air purifying system according to the first example.

FIG. 3 is a perspective view of a third step in applying a personal air purifying system according to the first example.

FIG. 4 is a perspective view of a fourth step in applying a personal air purifying system according to the first example.

FIG. 5 is a perspective view of a fifth step in applying a personal air purifying system according to the first example.

FIG. 6 is a perspective view of a sixth step in applying a personal air purifying system according to the first example.

FIG. 7 is a flowchart of a method of applying a personal air purifying system.

FIG. 8 is a partial perspective view of a visor portion of a personal air purifying system according to a second example.

FIG. 9 is a second partial perspective view of a visor portion of a personal air purifying system according to the second example.

FIG. 10 is a partial bottom view of a visor portion of a personal air purifying system according to the second example.

FIG. 11 is a third partial perspective view of a visor portion of a personal air purifying system according to the second example.

FIG. 12 is a partial perspective view of a visor portion of a personal air purifying system according to a third example.

FIG. 13 is a second partial perspective view of a visor portion of a personal air purifying system according to the third example.

FIG. 14 is a perspective view of a first step in applying a personal air purifying system according to the third example.

FIG. 15 is a perspective view of a second step in applying a personal air purifying system according to the third example.

FIG. 16 is a perspective view of a third step in applying a personal air purifying system according to the third example.

FIG. 17 is a partial perspective view of a visor portion of a personal air purifying system according to a fourth example.

FIG. 18 is a second partial perspective view of a visor portion of a personal air purifying system according to the fourth example.

FIG. 19 is a partial bottom view of a visor portion of a personal air purifying system according to the fourth example.

FIG. 20 is a second partial bottom view of a visor portion of a personal air purifying system according to the fourth example.

FIG. 21 is a partial perspective view of a visor portion of a personal air purifying system according to a fifth example.

FIG. 22 is a system block diagram of a fan module.

FIG. 23 is a partial perspective view of a personal air purifying system according to a sixth example.

FIG. 24 is a partial cutaway view of a fan module.

FIG. 25 is a partial perspective view of a visor portion assembly of a personal air purifying system according to a sixth example.

FIG. 26 is an exploded view of the visor portion assembly of FIG. 25.

FIG. 27 is a partial perspective view of a visor portion assembly of a personal air purifying system according to a seventh example.

FIG. 28 is an exploded view of the visor portion assembly of FIG. 27.

FIG. 29 is a front view of a harness assembly having a plurality of securing straps according to an example.

FIG. 30 is a partial perspective view of the harness assembly of FIG. 29.

FIG. 31 is an exploded view of an air delivery subsystem.

FIG. 32 is a partial exploded view of a fan module of the air delivery system of FIG. 31.

FIG. 33 is an exploded view of an air delivery subsystem according to an additional example.

FIG. 34 is a partial exploded view of a fan module of the air delivery system of FIG. 33.

FIG. 35 is a partial exploded view of an air filter housing portion having an air filter.

FIG. 36 is a front view of a filter according to an example.

FIG. 37 is a cross section along Line A-A through the filter of FIG. 36.

FIG. 38 is a front view of a fan module housing.

FIG. 39 is a cross section along Line A-A through the fan module housing of FIG. 38.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Moreover, except where otherwise expressly indicated, all numerical quantities in this disclosure are to be understood as modified by the word “about” in describing the broader scope of this disclosure. Practice within the numerical limits stated is generally preferred. Also, unless expressly stated to the contrary, the description of a group or class of materials by suitable or preferred for a given purpose in connection with the disclosure implies that mixtures of any two or more members of the group or class may be equally suitable or preferred.

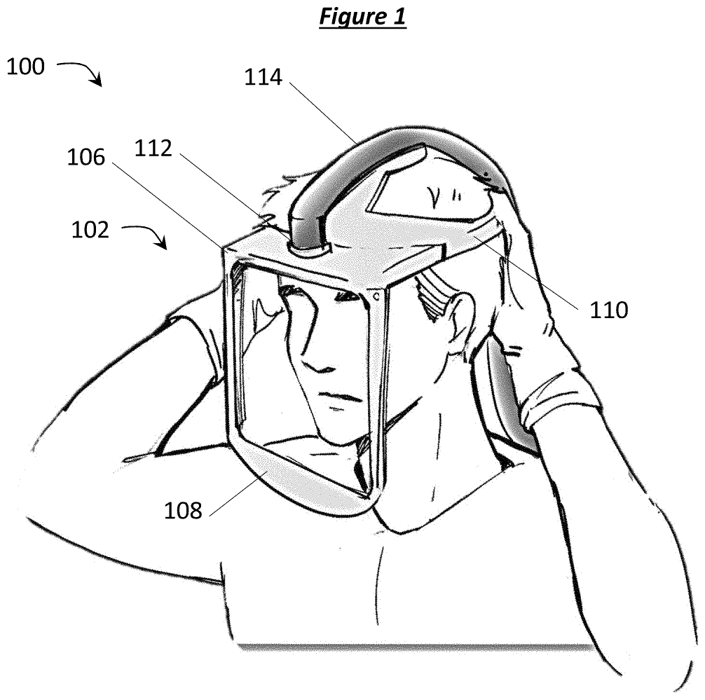

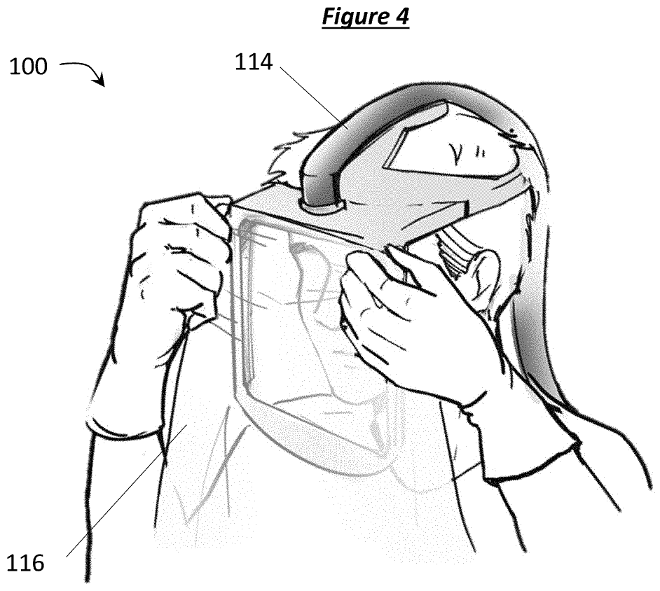

Referring collectively to FIG. 1 through FIG. 6, a powered air-purifying respirator (PAPR) system 100 is depicted. The PAPR system 100 may be used to isolate a user from undesirable external environments. Generally, the PAPR system 100 comprises two subsystems: a barrier subsystem 102, and an air delivery subsystem 104 adapted to cooperate with the barrier subsystem 102.

The barrier subsystem 102 includes a visor portion 106 near a user's face. The visor portion 106 may include a viewing frame 108 provided to define a field of view of the user. In some examples, the viewing frame 108 may encase a transparent rigid material in front of the user's face, such as a transparent polymer or glass. In other examples the viewing frame 108 may comprise an opening that is covered by a hood barrier discussed in more detail below. In further examples, the visor portion 106 may be contoured to match a jaw line shape of a user's face. In specific examples, the viewing frame 108 defines a height of about 30 mm and a width of about 200 mm.

As described in various examples of the present disclosure, the visor portion 106 may define a range of shapes including being part of a full helmet protecting a user's head. In the example of FIG. 1 through FIG. 6, the visor portion 106 includes one or more flexible straps 110 arranged to wrap around the head of a user to secure the barrier subsystem 102 in place relative to the user's field of view and breathing area. In this example, there are three flexible straps 110 that are contoured to conform to the shape and size of a user's head. Each of the flexible straps 110 are sized to allow a user to press fit the visor portion 106 about a range of different head sizes with moderate hand pressure. More specifically, each of the flexible straps 110 may have an elastic range of deformation so as to deflect during use to provide an opening to fit a user's head that is larger than an undeflected opening of the visor portion 106. Cantilevered portions of each flexible strap 110 are deflected during a fitting operation, and once secured, the visor portion 106 generates a clamp pressure upon the user's head. This clamp pressure allows the visor portion 106 to retain to the user's head as the contoured portion of each flexible strap 110 wraps the user's head. In some examples, and as described in more detail below, a supplemental band may be provided to assist retention force of the straps and enhance a customized fit to a user's head. In other examples the visor portion may be formed as a hat brim formation or other projection shape disposed above the user's face secured by a headband. Generally, the visor portion 106 is arranged to fit a range of different user head shapes and sizes. In further examples the PAPR system 100 may be configured to be retrofit over an existing hat or helmet. In each example the visor portion is configured to optimize the peripheral vision of the user.

An attachment port 112 is provided on the visor portion 106 to receive an output end of an air delivery pipe 114. The attachment port 112 is located above the user's face to exhaust filtered air downward into the user's breathing area. The attachment port 112 may include a standard fitting such as a threaded receiver to such a mating threaded portion at the output end of the air delivery pipe 114. In other examples, the attachment port may include a ribbed nozzle such that the output end of the air delivery pipe 114 may be press fit onto and retained to attachment port 112. One particular advantage of the location of the attachment port 112 is the direction of airflow delivered to the user helps to reduce fogging due to moisture within the field of view of the user.

The air delivery pipe 114 may be formed from a flexible material and configured to provide fluid communication to the air delivery subsystem 104. According to some examples, the air delivery pipe 114 is a corrugated flexible tube. In other examples, the air delivery pipe 114 is provided with smooth interior walls to facilitate airflow and cleaning. The air delivery pipe 114 is provided with sufficient length to span from the attachment port 112 to air delivery subsystem 104 that may be disposed near a user's waistband. In some specific examples, the air delivery pipe 114 is provided with a length of about 4 ft to 6 ft and defines an internal diameter of about 1.5-2.0 inches. As discussed above, the air delivery pipe 114 may also include any suitable connection type to provide a fluid seal for air delivery such a threaded fitting connection or a press-fit connection over a ribbed nozzle.

The visor portion 106 may be formed from a material suitable to be cleaned for reuse with chemical germicides as well as to be cleaned via physical methods. A polymer material may be suitable to be moisture-resistant and to withstand cleaning by chemical products such as those that are hydrogen peroxide-based, acid-based, chlorine-based, and glutaraldehyde-based by way of example. It should be appreciated that resistance to other types of chemical cleaning solutions may also be desirable. The visor portion 106 may also be adapted to withstand hot-water disinfection (e.g., pasteurization) and steam cleaning (e.g., via autoclave). The materials forming the visor portion 106 may also be selected to provide impact resistance without cracking or permanent deformation. In some examples, the visor portion 106 is formed from a polycarbonate or a high-density polyethylene material. In more specific examples the visor portion 106 is formed from polymer about 1.6 mm thick.

Non-polymer components of the visor portion 106 such as clips or other connecting hardware may be formed by a stainless-steel alloy to provide further moisture resistance and inhibition of germ proliferation.

The visor portion 106 is arranged to provide sufficient stiffness to hold in place relative to a user's face and also to support the routing of the air delivery pipe 114 and a barrier hood 116 discussed in more detail below. The air delivery pipe 114 may be routed upward from the visor portion 106, above the user's head, and behind the user so as to reduce any inhibition of the user's movement. Moreover, routing behind the user's torso may reduce the risk of damage to the air delivery pipe 114 during user activities. The air delivery pipe 114 may be secured in place relative to the visor portion 106 via any suitable securing means such as an elastic strap, clips, ratcheting zip-ties, or a hook-and-loop fabric strip (not shown).

A disposable barrier hood 116 is configured to cooperate with the visor portion 106. The barrier hood 116 may be fully transparent or include at least a transparent window or sub-portion to coincide with the user's field of view. The barrier hood 116 may be secured to the visor portion 106 to keep the transparent portion of the hood in place to maintain the position of the user's field of view during user movement. The barrier hood 116 defines a height sufficient to extend downward to overlap with a user's torso. Discussed in more detail below, the barrier hood 116 is intended to be disposable and replaceable. Thus, the barrier hood 116 is configured to provide simple installation and removal. In some examples, the barrier hood 116 is fully formed from transparent material and is shaped to contour to the shape of the user's head and visor portion 106 to remain in place via shape without the need for additional retention means. In other examples, and discussed in more detail below, the visor portion 106 may include a reusable adhesive means such as a polyurethane double-sided tape to locally retain the barrier hood 116 to the viewing frame 108 of the visor portion 106. In this way, a barrier hood may be removed and discarded following use, and a replacement barrier hood secured to the reusable adhesive means. In yet other examples, the barrier hood 116 may include an elastic or other similar structure at the lower portion thereof so self-adjustment by the user to desired fit and preferences.

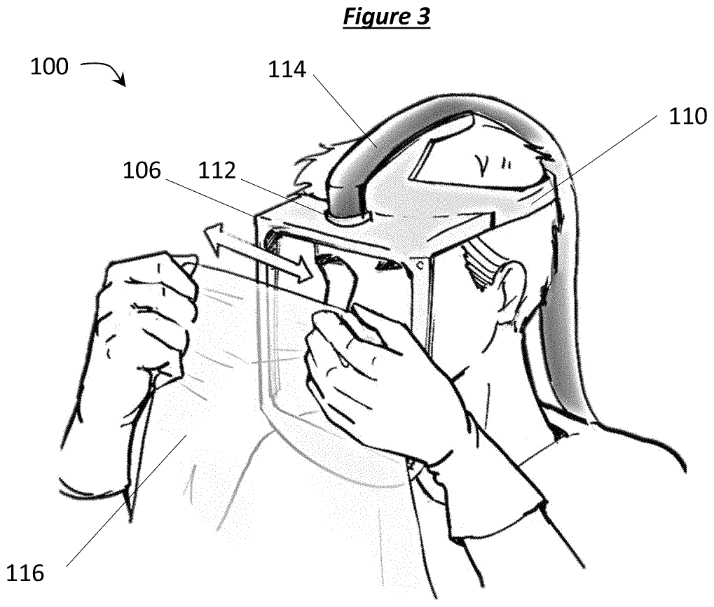

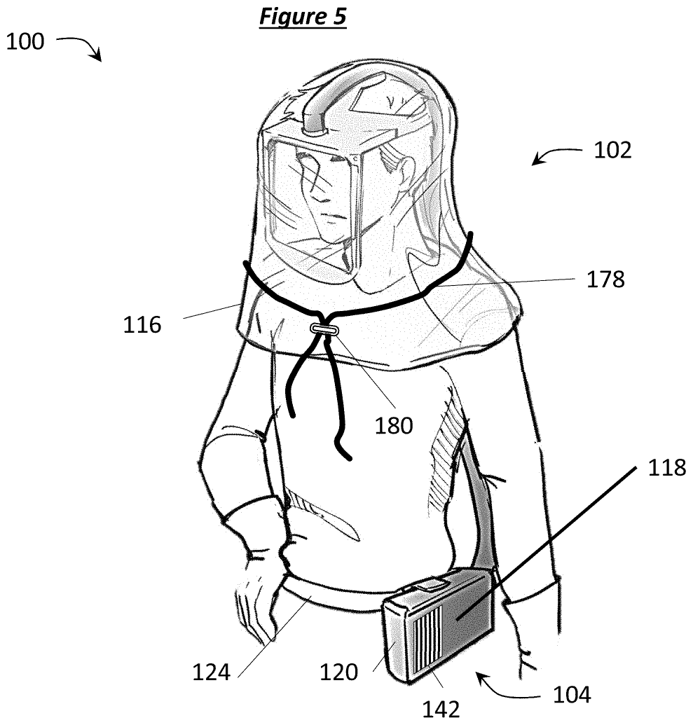

In additional examples, and best seen in the example of FIG. 3, the barrier hood 116 may be configured to stretch about the viewing frame 108 and self-retain to the visor portion 106. In further examples, the barrier hood 116 may be provided with a cinching means such as a draw string to allow the user to selectably pull the barrier hood 116 taught to the visor portion 106. With specific reference to FIG. 5, a draw string 178 may be provided to aid in securing the barrier hood 116. The draw string 178 may be held in place by a toggle 180 that allows a user to adjust the fit of the barrier hood 116 by releasing the toggle 180 and sliding its relative position along the draw string 178. The draw string 178 may be integrated into the barrier hood 116 or applied as a separate component over an outer portion of the barrier hood 116 once the barrier hood is in place.

In further still examples, the barrier hood 116 is configured to drape over the visor portion 106 where a user may wear additional outer layer garments over the lower portions of the barrier hood 116. The barrier hood 116 may be formed from any material suitable to provide an environmental barrier to isolate the user's breathing area from the external environment. Moreover, the barrier hood 116 may be formed from any material suitable to provide visibility through which a user may maintain a field of view. According to some examples, the barrier hood 116 is formed from a transparent polymer sheet material. In some specific examples, the barrier hood 116 is formed by polyethylene film from about 0.8 mils to about 3 mils thick.

The air delivery subsystem 104 includes a fan module 118 that may be secured to a user's person external to the barrier hood 116 and in fluid communication with the air delivery pipe 114. The fan module 118 includes a housing 120 to secure internal componentry and to define an attachment port 122 to fluidly connect to a supply end of the air delivery pipe 114. The housing portion 120 also defines an air inlet (not shown) to receive airflow from the external environment. According to some examples the housing portion 120 is formed from a thermoplastic material and includes mating half portions that are clamped together to define a sealed internal cavity. In further examples the half portions are hingedly connected to each other to define a clam shell configuration.

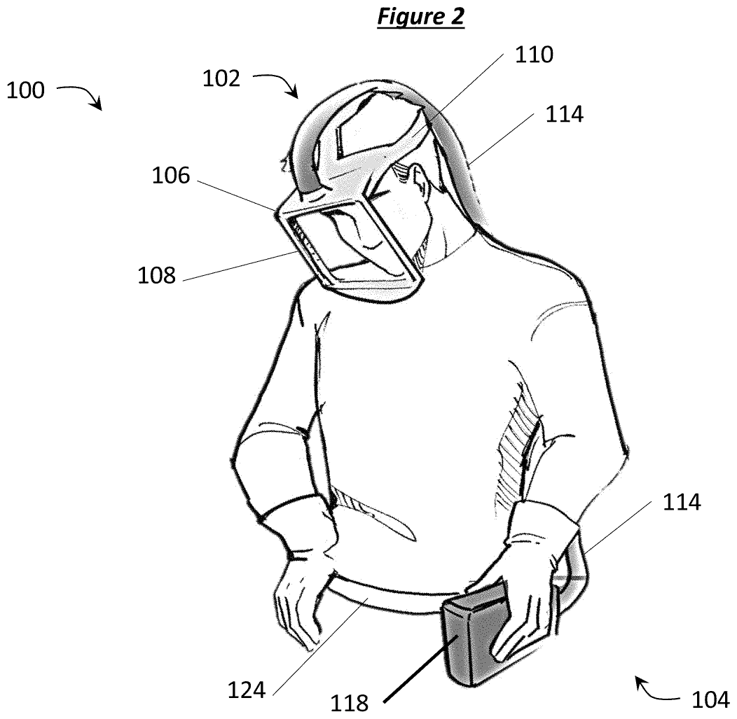

The housing 120 may also include a securing means to retain to a user's person. In some examples, the housing 120 is retained to a securing strap 124 by a retention mechanism such as one or more clips (not shown). The housing 120 may be configured to be retained to any convenient location on the user's person. As shown in the example of FIG. 2, when assembling the PAPR system 100, the user may secure the housing 120 of the fan module 118 to a belt near the user's hip. While a belt is depicted by way of example, it should be appreciated that a securing mechanism may be provided in any of a number of different configurations, including at least a should strap configuration and/or a cross-body strap configuration. While positioned near a user's hip, controls located on the fan module 118 may be easily reached by the user's hand and visible to the user. In alternate examples, the fan module 118 may be positioned near the small of a user's back and behind the user to reduce the risk of interference with the user's movements. In this case, supplemental controls may be provided such that the user may remotely control the fan module 118. The rear location of the fan module 118 may additionally enhance user comfort while moving. Moreover, the fan module 118 may be configured to be secured closely to the user's body to prevent cantilevering and unnecessary movement relative to its attachment point.

In further examples, the fan module 118 may be configured to articulate between multiple positions along the securing strap 124. In this way, a user may secure the fan module 118 at a first location and apply user control settings as discussed in more detail below. Then the user may articulate the fan module 118 to a preferred second position for extended period stowage such to provide more freedom of movement. The user may later return the fan module 118 near the first position for adjustment of user settings or removal. Related to ease of use it, may be desirable to limit the external dimensions and thus the overall size of the housing portion 120 of the fan module 118. According to some specific examples, the housing is limited to less than about 40 mm wide, less than about 125 mm in length, and less than about 125 mm in height.

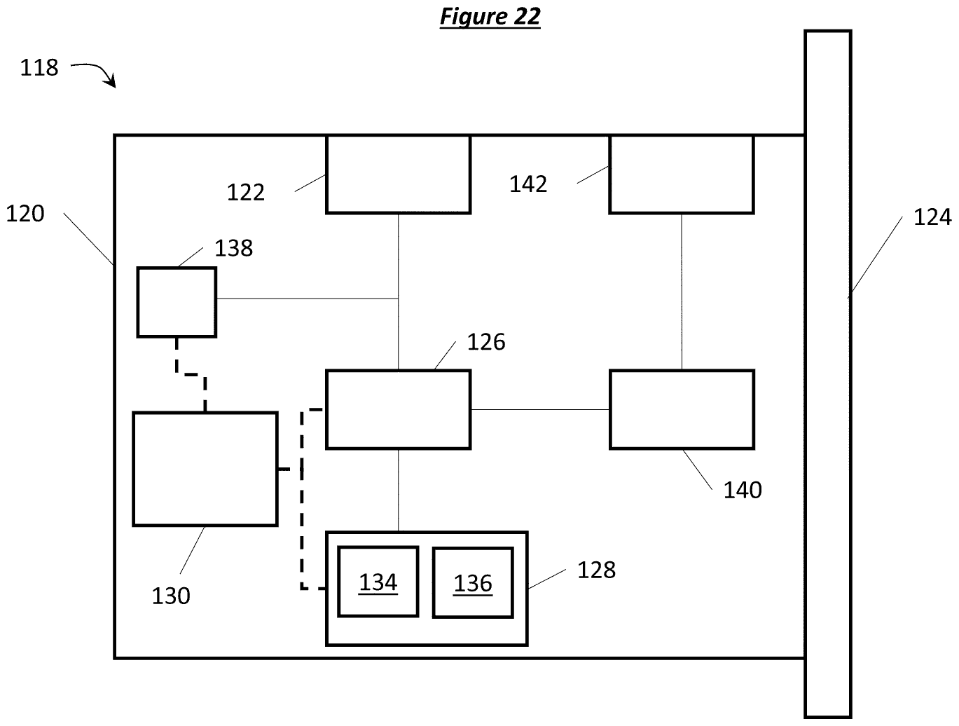

FIG. 22 is a system block diagram of a fan module. The fan module 118 may further include an internal fan mechanism 126 configured to draw in air from the external environment, and force air that has been treated through the air delivery pipe 114 for user consumption. The fan mechanism 126 may be configured as any number of suitable fan types, including a centrifugal direct current (DC) fan. The fan module 118 may provide a selectable variable output such that the user may input settings that influence airflow volume rates. In some examples, the fan module 118 includes selectable settings corresponding to a range of airflow rates from about 10 cfm to about 25 cfm. It should be appreciated that based at least upon the filtration media and air delivery pipe 114 geometry, other flow rates may be suitable to deliver a desired air speed volume. In further examples the fan module 118 includes logic to self-adjust based on flow resistance or back pressure, ambient pressure, temperature, humidity, or other factors that may influence desired target air delivery to a user. Related to limiting the size of the fan module 118, the fan mechanism 126 may include a fan blade equal to or less than about 80 mm that generates at least about 2 millibar static head pressure.

The fan module 118 may be powered by a power source 128 such as a rechargeable battery pack. According to some examples, the power source provides at least 37 watt-hours to provide a desired duration of continuous operation on a single charge. In this way the power source may be rated to operate at any of range of voltages, such as from about 5 V to about 24 V. In some specific examples, a motor driving the fan is rated at about 5-7 watts and is powered by 5 volts DC delivered by a battery provided onboard the fan module 118.

The power source 128 is configured to cooperate with a power input to replenish electrical charge that is depleted during fan operation. In some examples, the fan module 118 is provided with a customized charger having electrical settings tailored to a desired configuration. In other examples the fan module 118 includes a USB port to receive charge from at least one standard USB power input such as from a computer or cellular phone charger. In a specific example, a portable battery rated at about 10,000 mAh is provided and the fan module 118 is configured to provide charge via at least one of a USB-C port or a USB-A port. In further examples the fan module 118 is configured to provide power to recharge the power source via connection to a car charger 12 V power input. In some alternate examples the power source 128 is removable to facilitate charging via a docking station or other type of charging cradle. Moreover, simple removal of the power source may allow for convenient service and/or replacement.

The fan module 118 may also include one or more associated controllers to control, monitor, and coordinate the operation of the various components. According to some examples, the fan module includes controller 130 having control logic algorithms stored thereupon.

Controller 130, although represented as a single controller, may be implemented as one or more controllers. In some examples, multiple microprocessors having independent logic are provided to govern operation of the fan module 118. The controller 130 may include any number of subcomponents such as microprocessors, ASICs, ICs, memory (e.g., FLASH, ROM, RAM, EPROM and/or EEPROM) and software code to co-act with one another to perform various operations. The subcomponents allow onboard processing of commands and execute any number of predetermined routines according to a desired timing or alternatively in response to one or more inputs received from sensors provided with the PAPR system 100. The processors may be coupled to non-persistent storage and/or persistent storage. In an example configuration, the non-persistent storage is RAM, and the persistent storage is flash memory. In general, persistent (non-transitory) storage can include all forms of storage that maintain data when a computer or other device is powered down. The controller 130 may also store predetermined data within the memory, such as “look up tables” that are based on calculations and/or test data. Used herein, references to “a controller” refer to one or more controllers.

In some specific examples power source 128 includes a battery microprocessor that governs power management specific to the battery (e.g., recharging parameters, power delivery parameters). The power source 128 may include a current sensor 132 to output a signal indicative of a magnitude and direction of current flowing into or out of the power source 128. The power source 128 may also include a voltage sensor 134 to sense and output a signal indicative of, the voltage across the terminals of the power source 128. The power source 128 may further include one or more temperature sensors 136 such as thermistors or other types of temperature sensors. Such a temperature sensor 136 may be in communication with the controller 130 to provide data indicative of a temperature of one or more battery cells.

The fan module 118 may further include at least one pressure sensor 138 to monitor back pressure in the line that may be indicative of a pressure drop or build near the breathing area of the user beneath the mask. The controller 130 may read the pressure signal provided by the one or more pressure sensors and adjust output of the fan module in response.

The fan module 118 may further include a time estimation feature to calculate remaining battery power and provide output to a user indicative of remaining time of operation available on the present charge. In an example, the battery microprocessor may perform the time estimation feature by receiving a current voltage reading of the battery using the voltage sensor 134, converting the reading of the battery voltage to state of charge, using a predefined discharge curve of voltage vs. state of charge of the battery to determine the state of charge of the battery, and determining the remaining time based on the state of charge and the power usage of the fan module 118 based current measurement via the current sensor 132.

As discussed above, the PAPR system 100 is provided with one or more air filters 140. In some examples the air filters 140 are provided with the fan module 118 and disposed within the housing portion 120. More specifically, the one or more air filters 140 are disposed near an air inlet 142 of the fan module and configured to filter air drawn in from the external environment. In alternate examples air filters 140 may be located elsewhere within the PAPR system 100, such as near the outlet end of the air delivery pipe 114, as discussed in more detail below.

According to some examples, air filters 140 are provided as a pleated high efficiency particulate air (HEPA) type filter disposed within a sealed chamber within the fan module 118. The air filter 140 is configured to be sealed to its surroundings such that air flowing through the fan module 118 is forced through the filter 140 itself and preventing airflow from bypassing the filter. According to some examples the air filter 140 is provided with a frame that is clamped to a surrounding portion within the housing portion 120 to prevent air bypass. The filter 140 is configured to capture particulates and other undesirable substances that are taken in via air from the external environment. According to some examples the air filter 140 is configured to capture particles less than 0.12 microns. In a specific example, a HEPA type filter, the air filter 140 may provide an efficiency as high as 99.97% filtering particles of 0.3 micron size. According to other aspects of the present disclosure, the air filter 140 is specified to operate at a flow rate of about 170-280 liters per minute with a minimal loss of head pressure (e.g., about 6-12 mm of water).

In some other examples, the air delivery subsystem 104 may include antimicrobial features such as ultraviolet (UV) light treatment of air passing through to eliminate contaminants. In these examples the air delivery subsystem 104 may include at least one ballast and corresponding UV lamp to output ultraviolet light upon air passing through the PAPR 100 prior to delivery to the user. The air delivery subsystem 104 may also include a UV lamp sensor to monitor operation and efficacy of the UV light treatment and output a signal of error states and/or suboptimal operation. Additional treatment with liquid sanitizers is also contemplated.

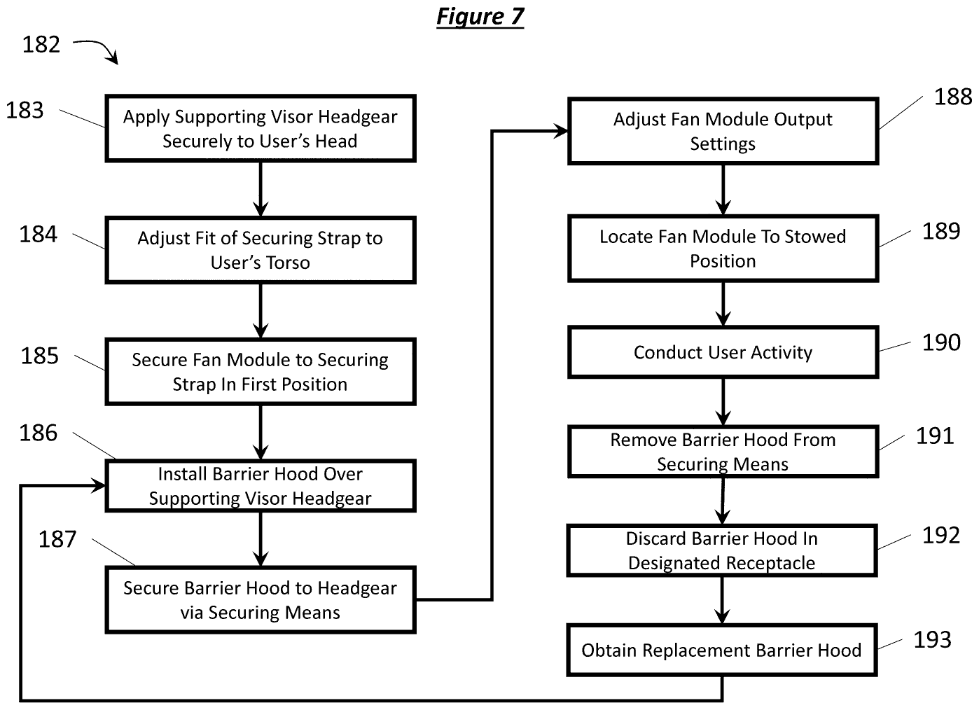

FIG. 1 through FIG. 6 also concurrently depict sequential usage steps corresponding to method 182 depicted in FIG. 7. At step 183 the method includes applying the supporting visor headgear securely to the user's head where the visor portion corresponds to the user's field of view. As discussed above, a visor portion 106 may be fitted to a number of different head shapes and sizes via one or more deflectable members that applies a clamp pressure when fitted to a user's head to hold the visor in place. In alternate examples an adjustable band is pulled to adjust a head opening to conform to a user's head. In this way the tightness can be selected by a user to accommodate desired comfort while still maintaining retention of the visor headgear to the user's head.

At step 184 the method includes adjusting the securing strap 110 to be secured to the user's person. As discussed above, the securing strap 110 may be provided as a belt, shoulder sling, cross-body strap or other suitable securing means held to the user's torso. In alternate examples the method may include applying a vest to the user's person wherein the vest includes retention features to hold the fan module 118.

At step 185 the method includes securing the fan module 118 to the securing strap. Also discussed above, the securing strap 110 may provide multiple position for securing the fan module 118 depending on a user's preference for the final stowed location of the fan module 118 during user activities.

At step 186 the method includes installing a disposable barrier hood 116 over the supporting visor portion 106 of the headgear. The user may stretch the barrier hood 116 during application as depicted in FIG. 3 such that a contoured shape of the barrier hood 116 snugly conforms to the shape of the headgear as worn by the user. An additional consideration in installing the barrier hood 116 to the supporting headgear is to create a flush or close to flush engagement between the barrier hood 116 and the visor portion 106, for that reason, the step of this method focusing on securing the barrier hood 116 in the area of the visor by the securing means employed prior to placement of the remainder of the barrier hood 116.

At step 187 the method includes securing the barrier hood 116 to the supporting visor portion 106 of the headgear. This may include utilizing any number of supplemental securing means, including at least a reusable adhesive tape, adhesive or static areas, bands, straps or other mechanisms to hold the barrier hood securely in place. As described above, the barrier hood 116 may be self-retaining in some examples and thus not require supplemental securing means.

At step 188 the method includes powering on the fan module 118 and adjusting the fan module 118 output setting to a desired level. The fan module 118 may include a user interface having a number of settings to influence the degree of powered airflow provided to the user's breathing area. The fan module 118 may further output feedback to the user indicative of the operation state of the fan module 118. In some examples, user feedback may include at least one of a battery status, a filter status, and a back-pressure status indictive of airflow blockage.

At step 189 the method includes locating the fan module 118 to a desired stowed position if the install position set at step 185 differs from desired stow position during operation. In this way the user may articulate the fan module 118 from a first position that facilitates installation to a second position that facilitates stowage during user activities.

At step 190 the method includes conducting user activity with the barrier hood 116 in place whole the user receives filtered air for breathing. The barrier 116 as installed isolates the user's face and breathing area from external environments which may include undesirable breathing conditions.

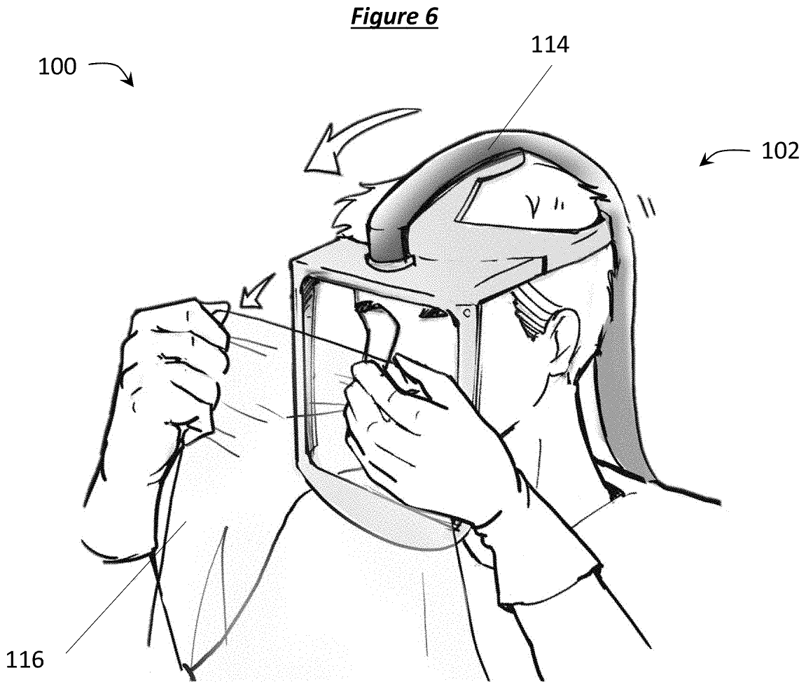

At step 191 the method includes removing the barrier hood 116 following the completion of the user activity. As discussed above the barrier hood 116 is configured to be inexpensive, disposable, and provide convenient installation as well as removal. In this way the user may easily remove the barrier hood 116 as depicted for example in FIG. 6 without removing or disturbing the set position of the visor portion 106 of the headgear. Specifically, the back portion of the barrier hood 116 may be drawn over a user's head either before or after the removal of the supplemental securing means depending of the means selected.

At step 192 the method includes discarding the barrier hood 116 in a designated receptacle. During user activity the barrier hood 116 may become soiled or otherwise contaminated. Related to the generally bag-shaped contour of the barrier hood 116, the user may invert the bag during removal such that any soiling or debris may be contained within an inner cavity once inverted. The inverted barrier hood 116 may then be tied up or otherwise sealed to contain the soiling or debris within the sealed inner portion following disposal.

At step 193 the method includes obtaining a clean replacement disposable barrier hood 116 for use with the previously-applied supporting visor portion 106 of the headgear. As the user returns to further activity requiring environmental and/or breathing isolation, there is no need to re-secure the headgear or fan module 118. Moreover, the cleaning of soiling or other contamination is not required, only replacement of the outer barrier hood 116 that provides isolation to the external environment.

The method includes returning to step 186 and installing the replacement barrier hood 116 over the previously-applied supporting visor portion 106 headgear such that the user may continue to conduct user activity with an isolation barrier in place without the need for removal of the air filtration hardware or other protective gear. Additionally, the supporting visor portion 106 headgear can be cleaned and reused for future user activity with a new replacement disposable protective barrier hood 116 by repeating the process depicting beginning in FIG. 1.

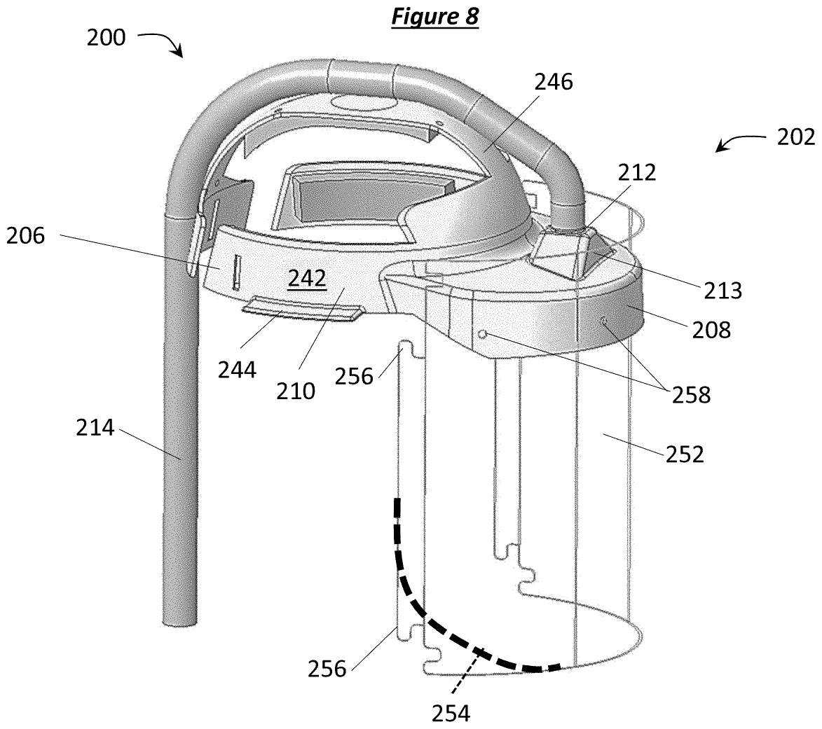

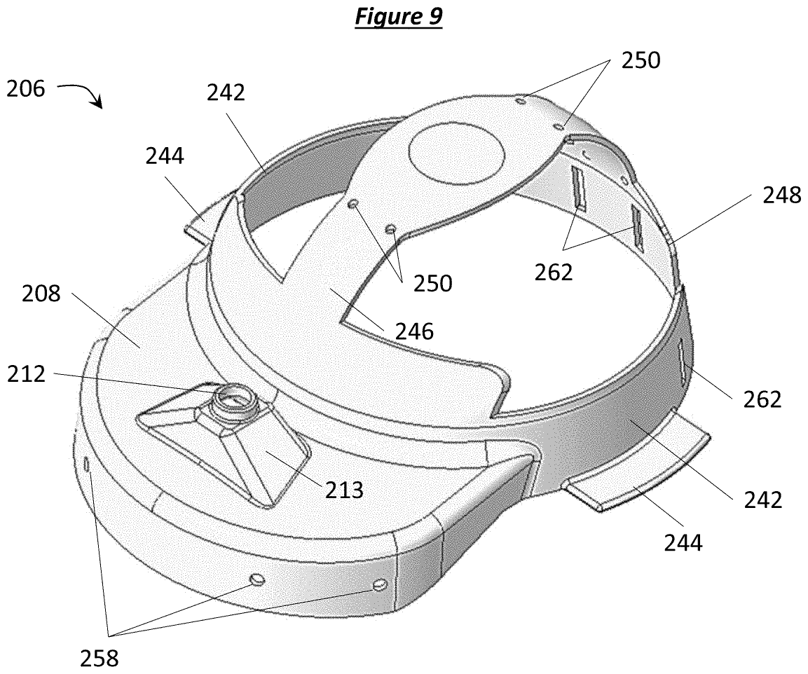

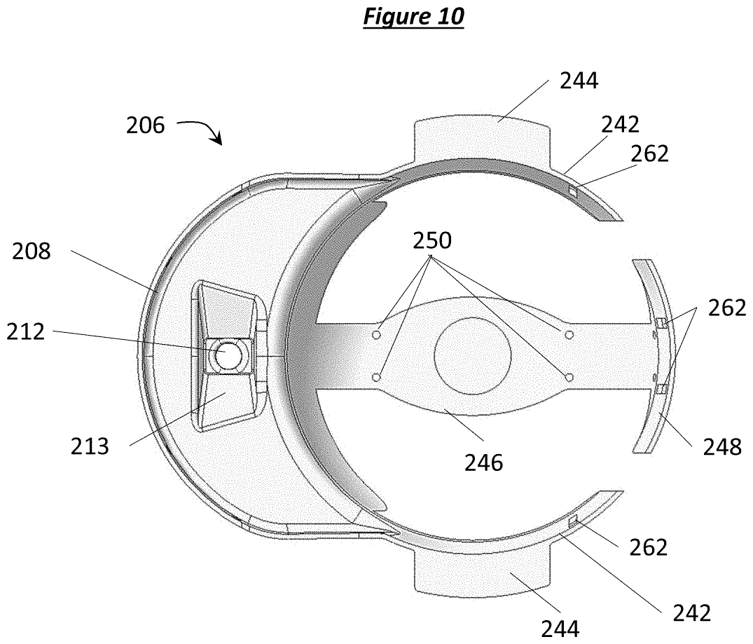

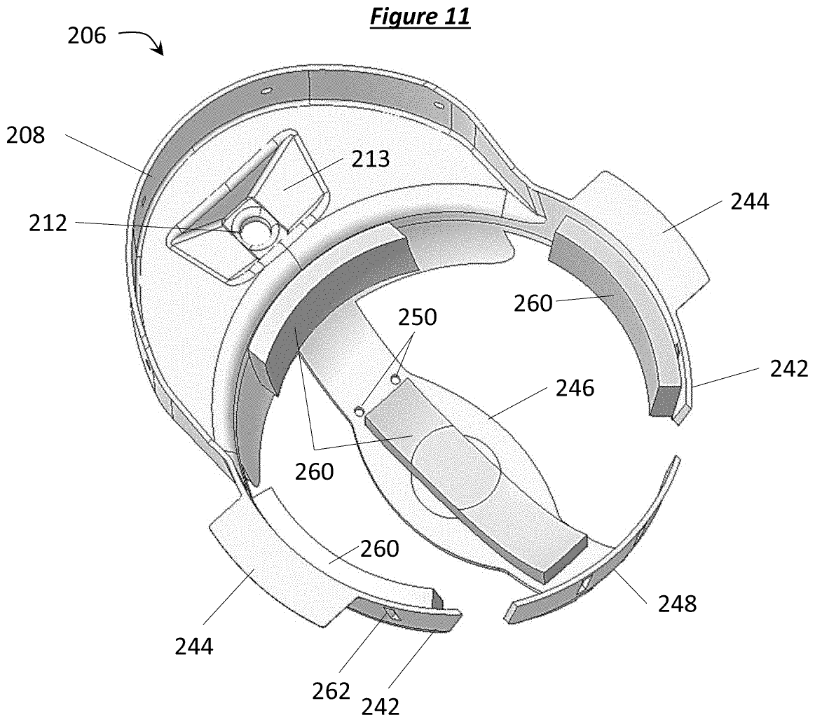

Referring collectively to FIG. 8 through FIG. 11, an additional example PAPR system 200 is provided. Where applicable, a similar reference numbering convention is applied that corresponds to similar components of previous examples, but with a difference in hundreds digit. The PAPR system 200 includes a barrier subsystem 202 having a visor portion 206 that does not include an integrated viewing frame as shown in previous examples. Instead, the visor portion 206 defines a brim 208 disposed above the user's breathing area and field of view.

Similar to previous examples, an attachment port 212 is disposed on the brim 208 to facilitate fluid communication to an air delivery pipe 214 at an output end arranged to supply filtered air for user consumption. In some examples, the brim 208 defines a flared portion 213 formed therein to facilitate dispersion of airflow delivered through the attachment port 212.

The visor portion 206 includes three straps 210 arranged to conform to a user's head to hold the visor portion 206 in place during use. A pair of laterally opposing side straps 242 are arranged to provide retention pressure to respective opposing sides of a user's head. Similar to examples described above, the laterally opposing side straps 242 are contoured to conform to the shape and size of a user's head. The laterally opposing side straps 242 easily flex through an elastic range of deformation so as to deflect use to provide an opening to fit a user's head that is larger than an undeflected opening of the visor portion 206.

One or more spacing tabs 244 protrude outwardly from each of the laterally opposing side straps 242 and may be adapted to create an air gap between the side of a user's head and a barrier hood installed over the visor portion 206. Depending at least upon the spacing, position, and size of the spacing tabs 244, airflow within the barrier hood may be directed to predetermined areas.

A center strap 246 extends upwardly from the brim 208 and extends over the top of a user's head. The center strap 246 includes a rear bracing portion 248 that supports the visor portion 206 against the back of a user's head. The center strap 246 generates a retention pressure to fore and aft portions of a user's head. Similar to examples described above, the center strap 246 is contoured to conform to the shape and size of a user's head. The center strap 246 also flexes through an elastic range of deformation so as to deflect use to provide an opening to fit a user's head that is larger than an undeflected opening of the visor portion 206. According to some examples a fabric adjustment strap (not shown) is routed through each of the laterally opposing side straps 242 and the rear bracing portion 248 of the center strap 246 to manually adjust the fit and/or tightness of the visor portion 206 upon a user's head.

At least one pipe retention feature 250 is disposed along the center strap 246 to retain the air delivery pipe 214 thereto. In the example of FIG. 8 through FIG. 11, the retention features 250 holes to receive a tie, pushpin, strap, or other securing mechanism (not shown) to hold the air delivery pipe 214 in place against the center strap 246.

The PAPR system 200 also includes a face shield 252 extending from the brim 208. The face shield 252 may be formed from a transparent polymer material, glass, or other material that allows the user to see therethrough during use. The face shield 252 is also configured to provide spacing to the user's face and maintain a desired distance to accommodate a suitable breathing area. Similar to above examples, the attachment port 212 is located above the face shield 252 to deliver filtered air as well as provide anti-fogging properties.

The face shield 252 may be shaped to wrap around to lateral portions of the user's face to maintain a field of view. The face shield 252 may also be shaped to mimic the shape of a user's face or jaw line to facilitate comfortable head movement. According to at least one example the face shield 252 defines a contoured portion 254 near a lower edge that mimics the shape of a jaw line.

At least one hood retention feature 256 may be provided on the face shield 252. The hood retention features may be adapted to hold a barrier hood 216 against the face shield 252. In the example of FIG. 8, hood retention features 256 are provided as vertically opposing tabs. Providing the hood retention features 256 as tabs may facilitate application of rubber bands or other elastic straps once the barrier hood 216 is in place to secure the position of the barrier hood 216 against the face shield 252.

At least one shield retention feature 258 is disposed on the brim 208 to attach the face shield 252 to the visor portion 206. In the example of FIG. 8 through FIG. 11, the shield retention features 258 are provided as holes to receive a mechanical fastening means to secure the face shield 252 against the brim 208. Rivets, screws, push pins, or other fastening means such as Christmas tree styled fasteners may be suitable to secure the face shield 252. It should be appreciated that adhesive bonding, friction welding, or other attachment means may also be suitable.

One or more cushion pads 260 may be disposed at various locations around the visor portion 206 to interface with the user's head. The cushion pads 260 provide comfort to the user while the PAPR system 200 is in use. The cushion pads 260 also conform to accommodate different head sizes and shapes in addition to the deformation of the straps 210. The cushion pads 260 may be secured to a respective strap via adhesive or mechanically retained. The cantilevered straps allow for a tight fitting among many different head sizes. In some examples the cushion pads 260 are secure to at least the laterally opposing side straps 242 via cushion retention features 262. In at least one specific example the cushion pads 260 are provided as polyurethane foam blocks located at fore and aft head locations, side hide locations, and at least one top head location. Further, the foam blocks may be sized to be about 6-15 mm in thickness to provide adequate compression depth while the visor portion 206 is worn by a user. Further still, at least one mechanical fastener is pressed through a cushion pad to engage a cushion retention feature 262.

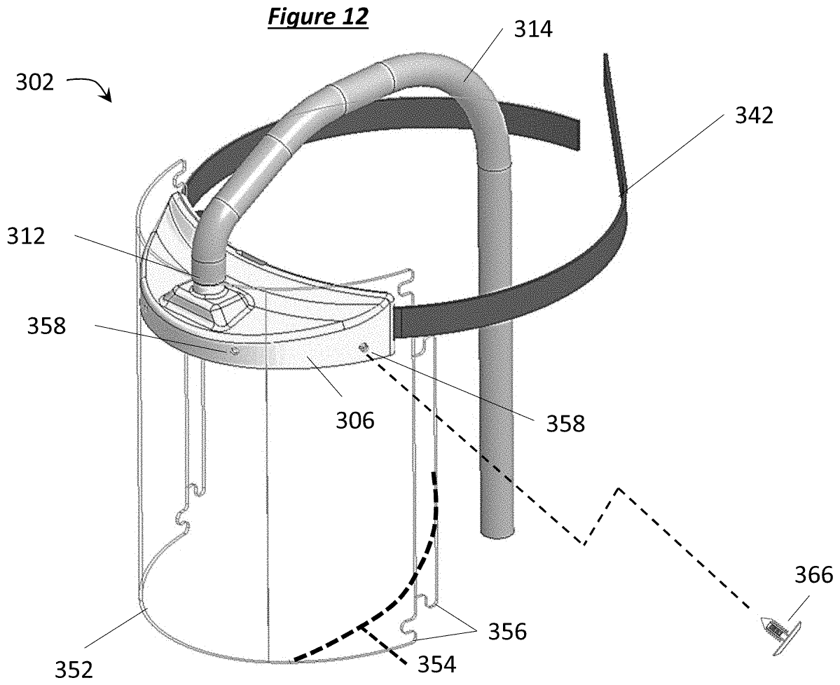

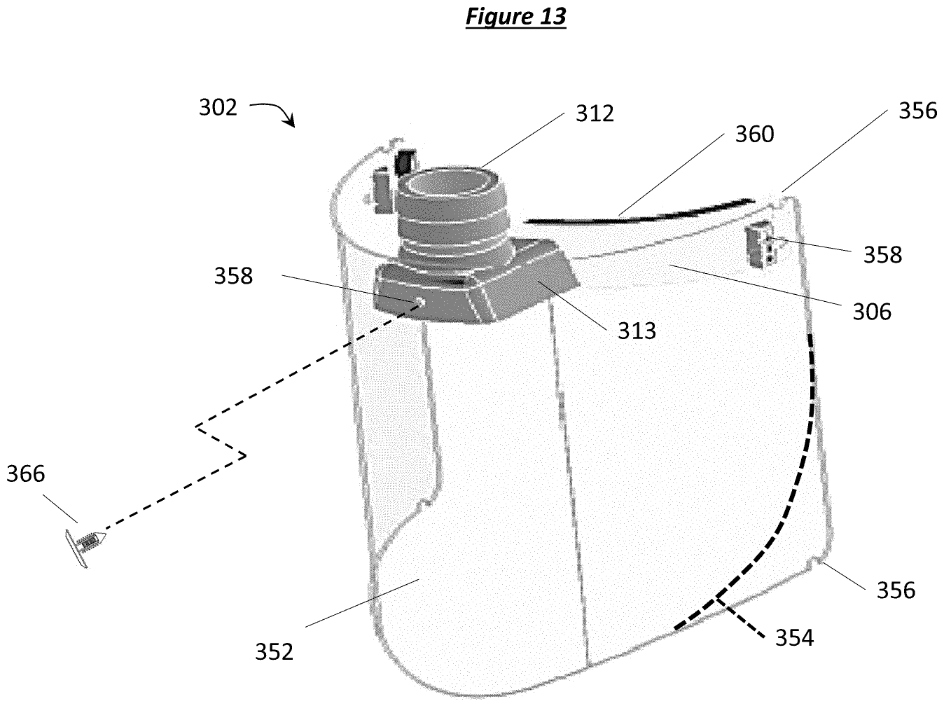

Referring collectively to FIG. 12 through FIG. 16, partial views of an additional example PAPR system 300 is depicted. Where applicable, a similar reference numbering convention is applied that corresponds to similar components of previous examples. In this example, a barrier subsystem 302 includes a visor portion 306 that is provided as a plurality of flexible band and a minimized brim 308. More specially, each of the laterally opposing side straps 342 and a center strap 346 are provided as flexible bands that are adjustable to fit snugly upon a user's head.

A face shield 352 is secured to the brim 308 similar to previous examples via one or more shield retention features 358. In some specific examples, one or more bosses is provided to receive a mechanical fastener 366 such as a screw, rivet, push pin, “Christmas tree” styled fastener, or other suitable type to secure the face shield 352 to the brim 308. A lower edge of the face shield 352 may be angled to align with the jawbone of the user or preferably lower than and aligned with the jawbone of the user as shown by the phantom line indicated by numeral 354.

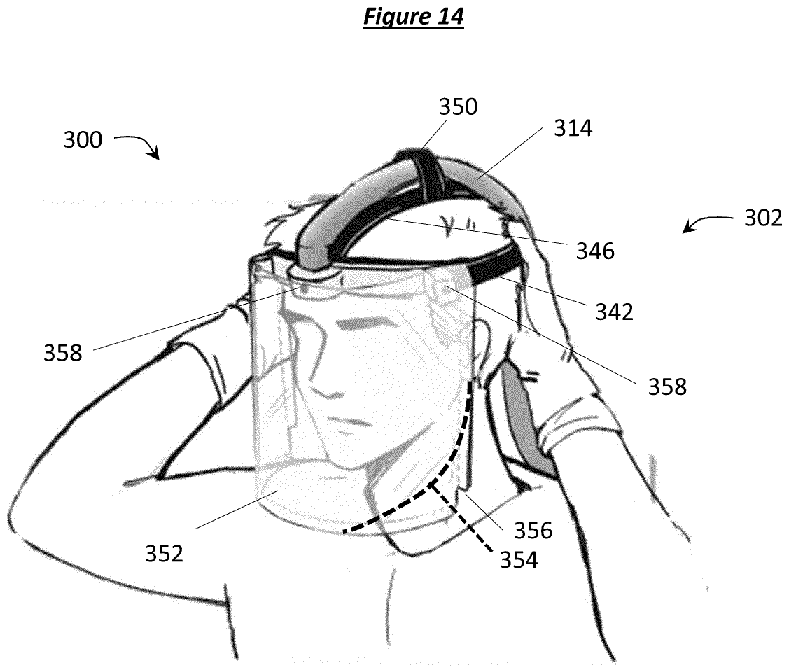

An air delivery pipe 314 is retained to the visor portion 306 via one or more pipe retention features 350. As best shown in FIG. 14, a band may be wrapped around a circumference of the air delivery pipe 314 and a center strap 346 of the visor portion 306.

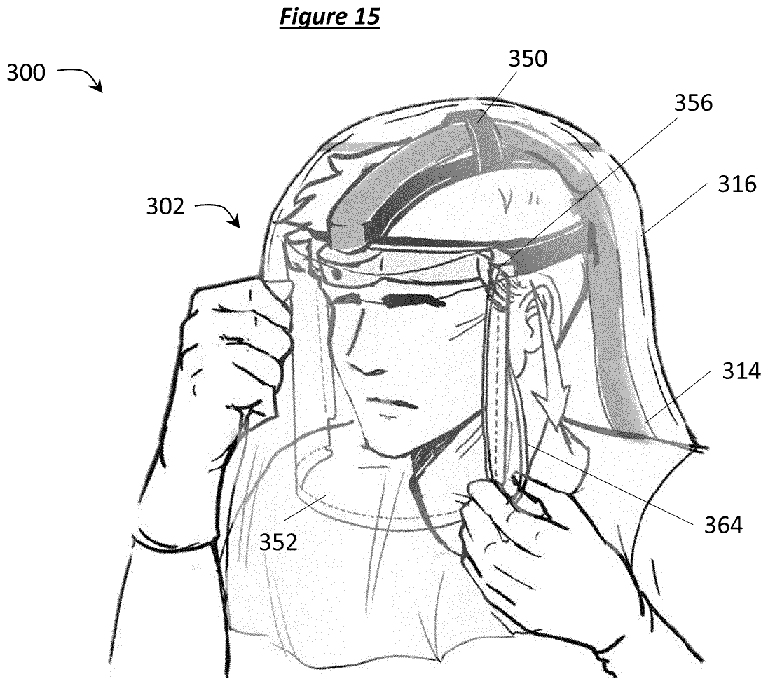

With particular reference to FIG. 15, a user may secure a hood barrier 316 about the visor portion 306 via one or more hood retention features 356 disposed on the face shield 352. In some specific example, a securing band 364 is engaged to an upper hood retention feature 356 provided as a notch in the face shield 352 and pulled downward to engage a lower hood retention feature also provided as an opposing notch. In at least one more specific example the securing band 364 is provided as a disposable rubber band that replaced with each subsequent use of a barrier hood.

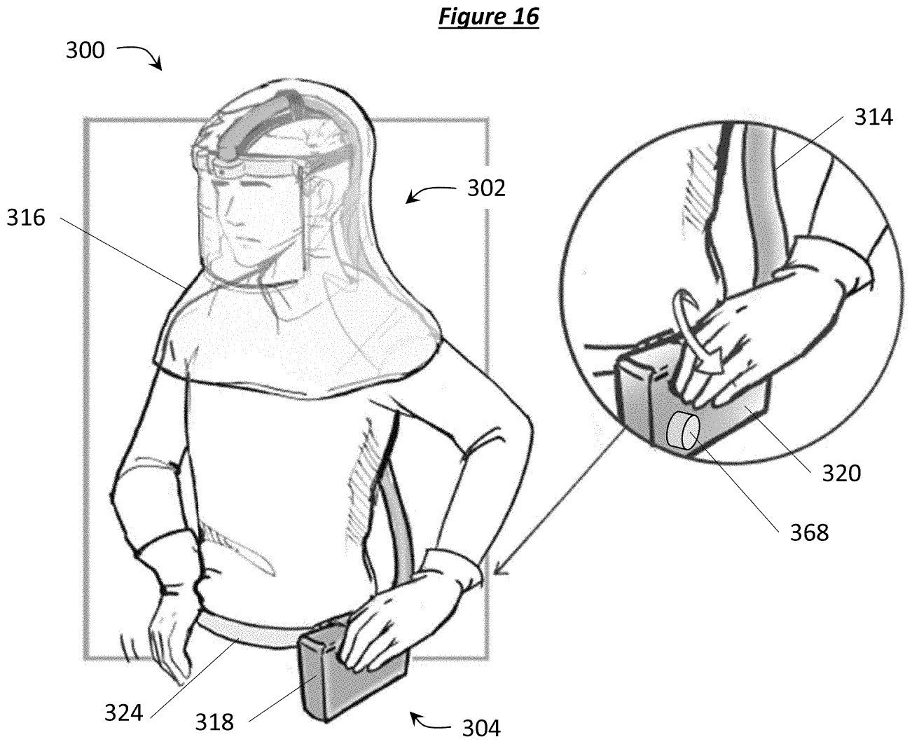

With particular reference to FIG. 16, a fan module 318 includes a user interface portion 368 that allows a user to control airflow settings. In some examples, the user interface portion 368 is provided as an output knob, or buttons that allow the user to increase and/or decrease airflow output as desired. In other examples, the user interface portion 368 further includes a display and/or audible output to provide the user with information regarding operation conditions of the fan module 318.

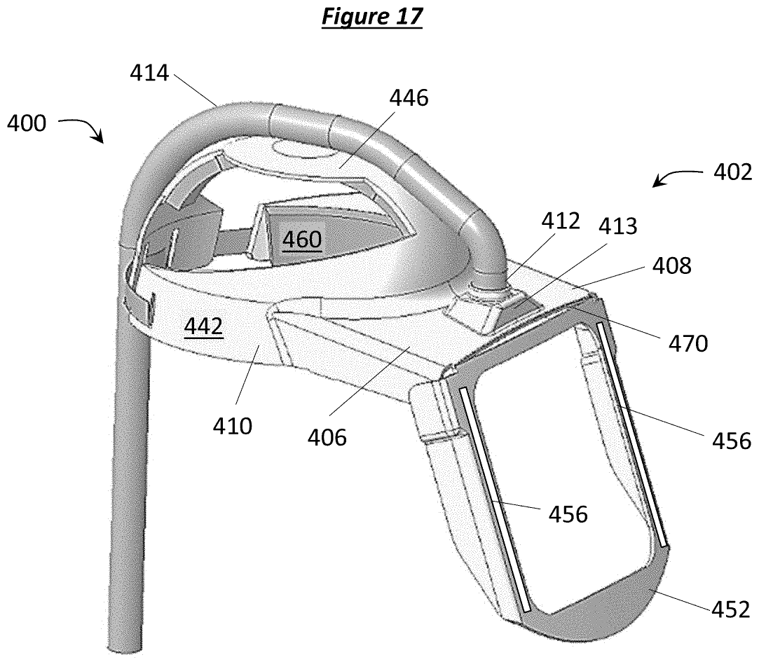

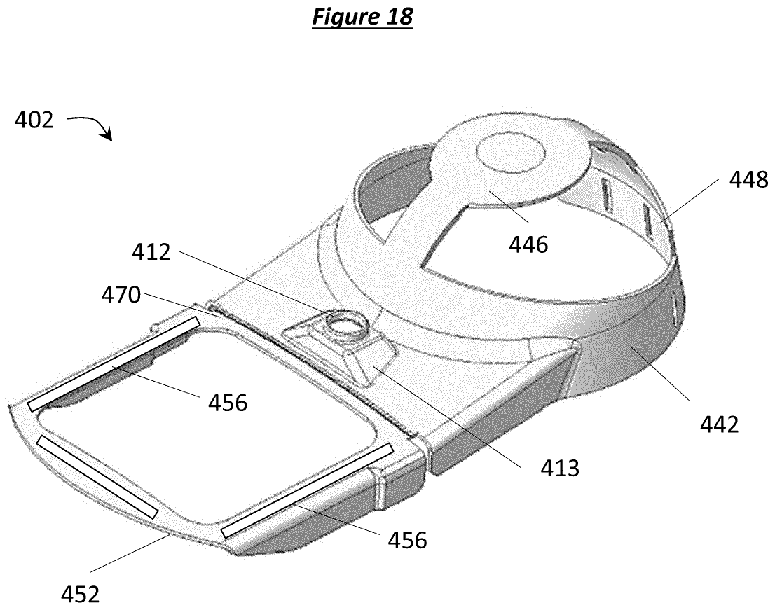

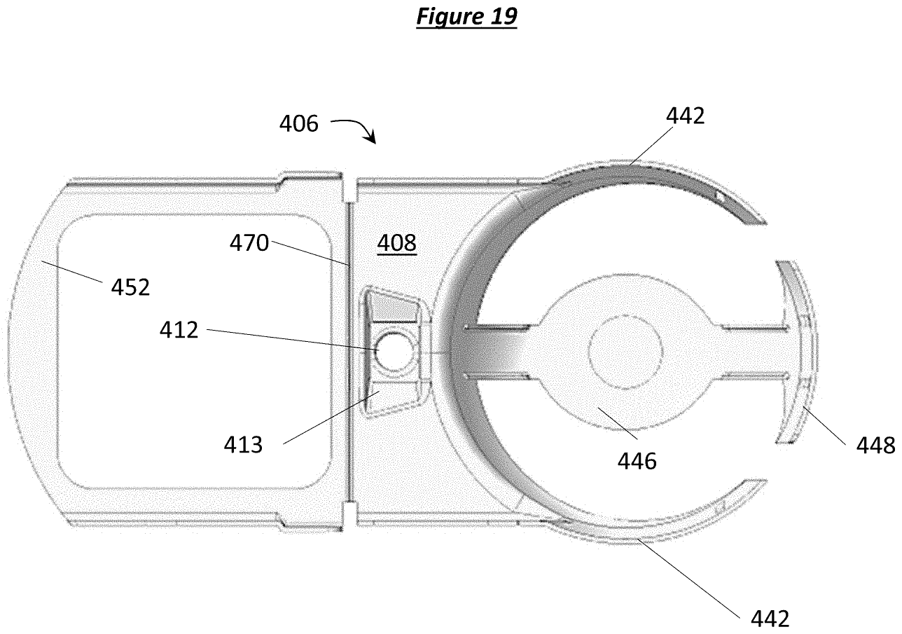

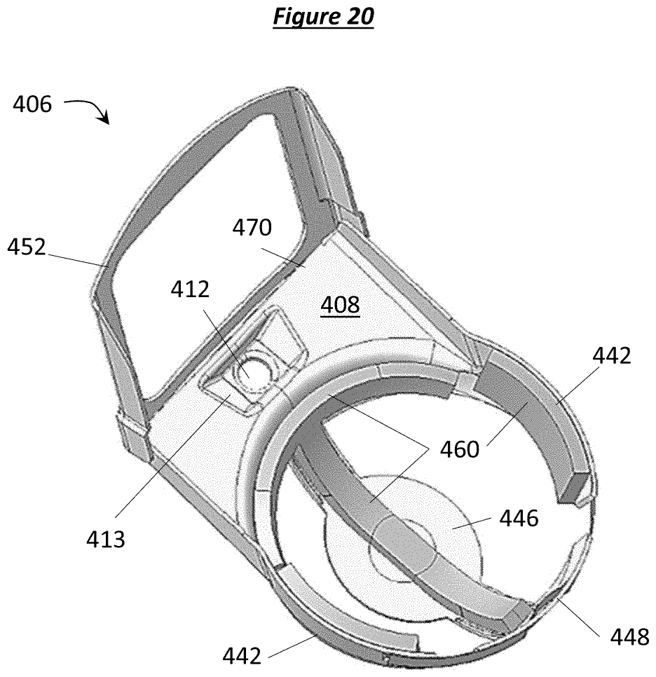

With specific reference to FIG. 17 through FIG. 20, partial views of an additional example PAPR system 400 is depicted. Where applicable, a similar reference numbering convention is applied that corresponds to similar components of previous examples. In this example, a barrier subsystem 302 includes a visor portion 406 that includes a hingeable face shield 452 having a frame the surrounds the user's field of view. A hinge 470 allows the face shield 452 to pivot relative to a brim 408 of the visor portion 406. In some examples the hinge 470 is a living hinge that is integrally formed in the visor portion 406 during a polymer injection molding process with a thinned section in the mold. In alternate embodiments, the hinge 470 may be assembled to each of the brim 408 and face shield 452 to allow pivoting therebetween.

The visor portion 406 also includes barrier hood retention features 456 configured to secure the barrier hood 416 to the face shield 452. In this case the hood retention features 456 are provided as reusable double-sided tape or other adhesive or static based items such that the barrier hood may be adhered to the visor portion.

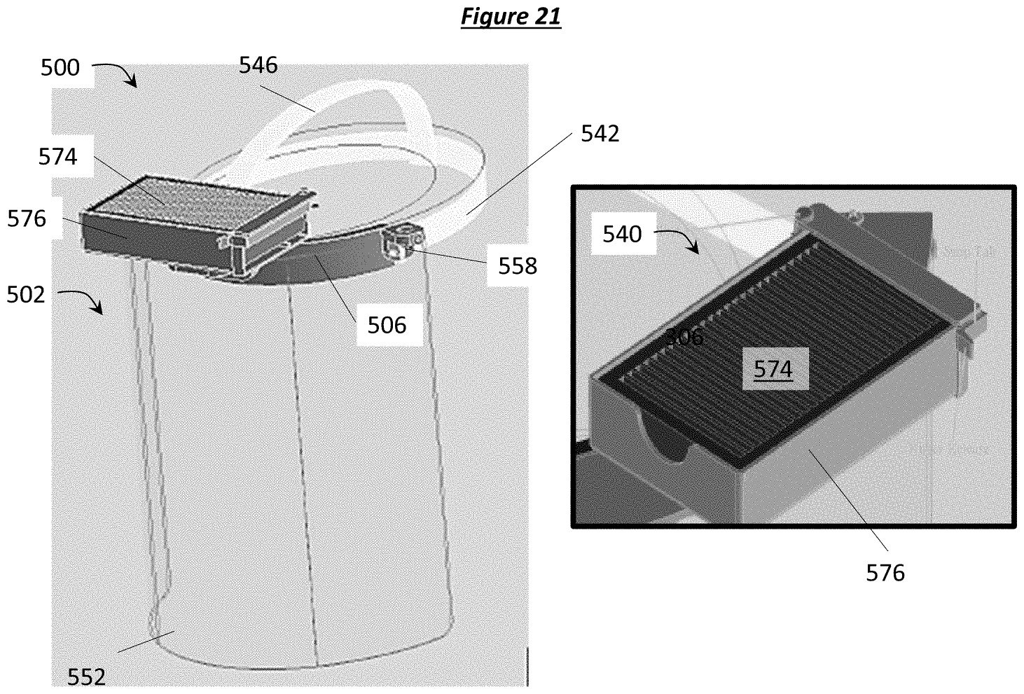

With specific reference to FIG. 21, a further example PAPR system 500 is depicted. Where applicable, a similar reference numbering convention is applied that corresponds to similar components of previous examples. In the example of FIG. 21, a filter 540 is disposed near the visor portion 506. The filter 540 may be provided in addition to or in lieu of an air filter disposed at a fan module 518. In some examples a small fan 572 (e.g., such as a 12 V, 7 cfm computer fan) is mounted directly to the top of the visor portion 506. A filter cartridge 574, such as a HEPA filter cartridge, is mounted into a housing 576 that attaches to the visor portion 506 above the fan 572 (not shown). The filter housing 576 may include a small pivoting arm that retains the filter cartridge 574 vertically, with a snap tab that allows for quick and easy replacement of the HEPA filter cartridge 574. A barrier hood 516 may be configured for easy placement around the housing 576 of the filter cartridge 574.

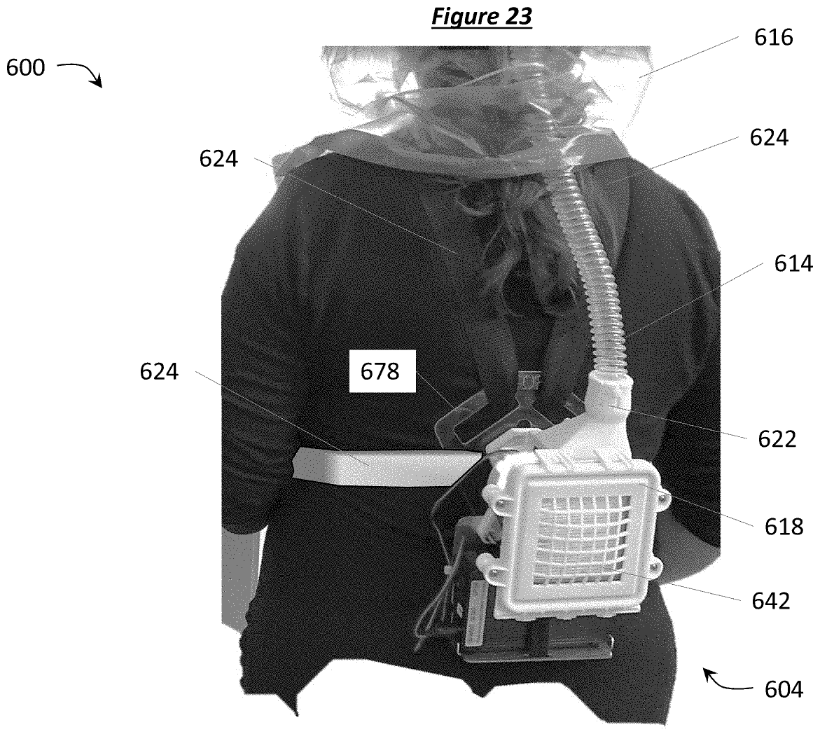

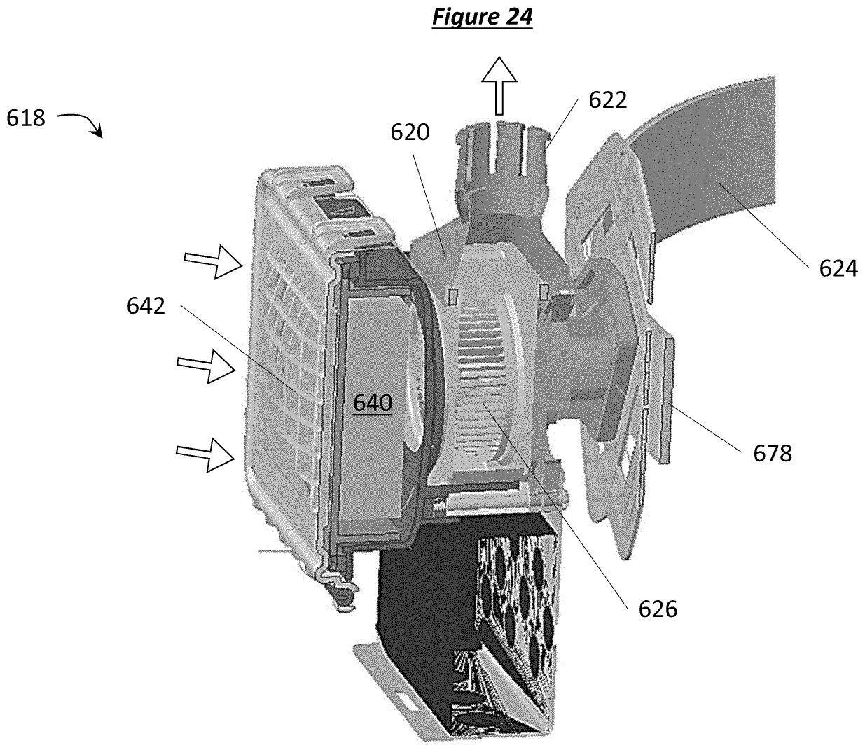

Referring to FIG. 23 and FIG. 24, a further example PAPR system 600 is depicted. Where applicable, a similar reference numbering convention is applied that corresponds to similar components of previous examples. In this example, an air delivery subsystem 604 includes a fan module 618 that is adapted to be affixed to a user's back. More specifically, the fan module may be configured to be worn as a backpack having a plurality of securing straps 624. Each of the securing straps may be routed through a lumbar support plate 678. A housing 620 of the fan module 618 may also be affixed to the lumbar support plate 678 such that an inlet 642 is rearward facing when the fan module is fitted to a user.

Similar to previous examples, the fan module 618 includes a centrifugal fan mechanism 626 disposed within a housing 620. Air is taken in the inlet 642 and forced through a filter 640 to remove particulates and other contaminants. Filtered air is then routed though the attachment port 622 to the supply end of an air delivery pipe (not shown) as described in previous examples.

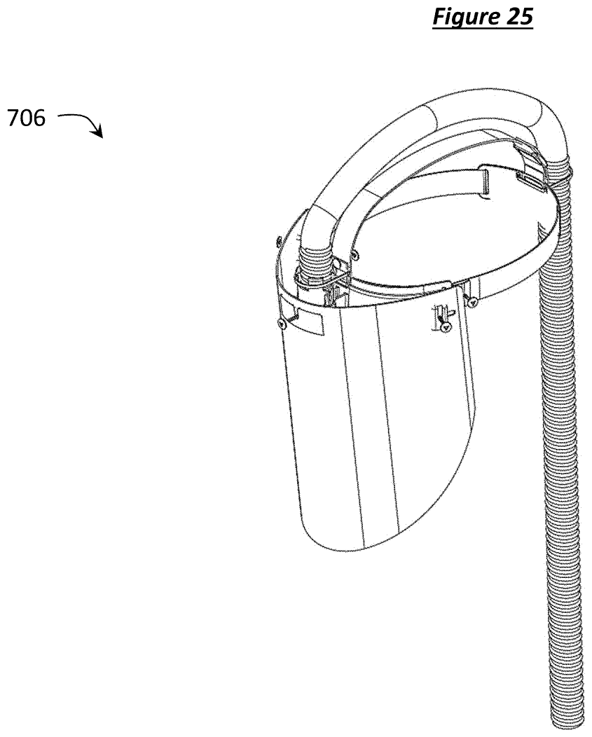

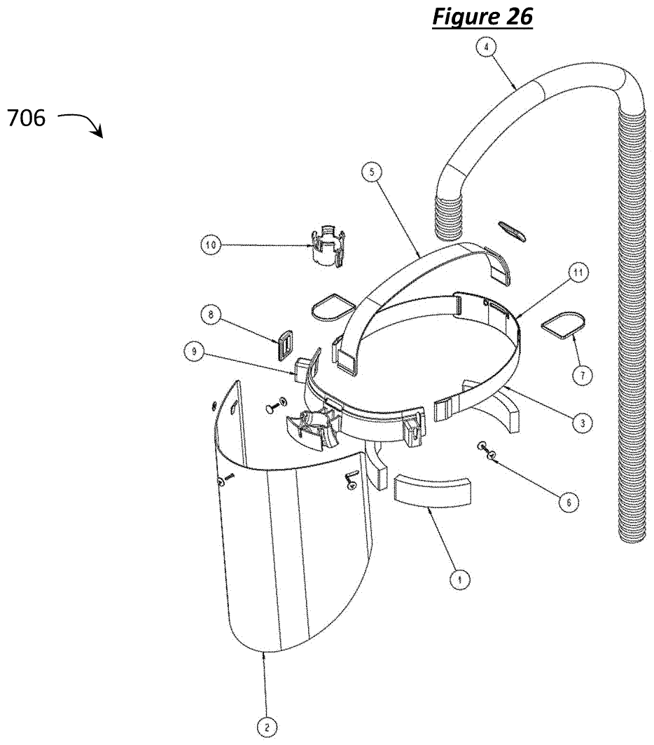

Referring collectively to FIG. 25 and FIG. 26, a visor portion assembly 706 includes a multi-piece visor having a plurality of straps. Similar to other examples, at least one flexible band is provided in cooperation with the straps to secure the visor portion assembly 706 to a user's head. A face shield may be secured to the visor portion assembly 706 via a number of securing fasteners. An air delivery pipe may be secured to the visor portion assembly 706 by one or more pipe retention features. An attachment port may be integrally formed with a front segment of the visor portion assembly 706.

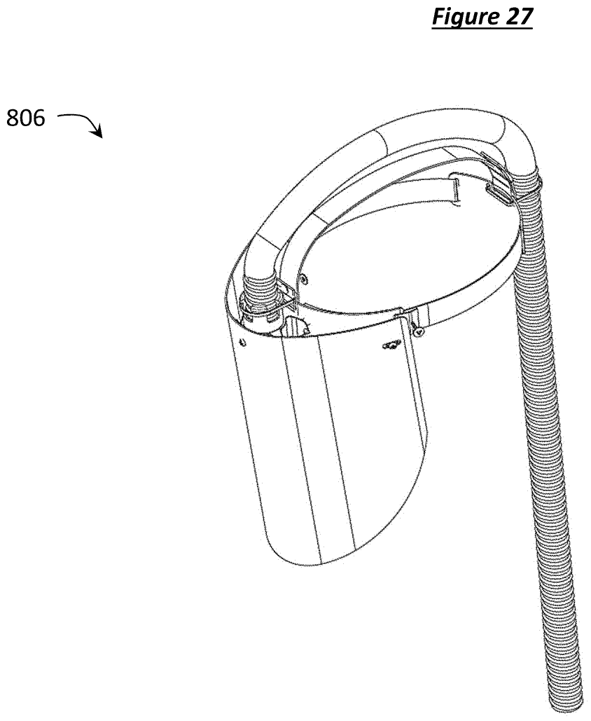

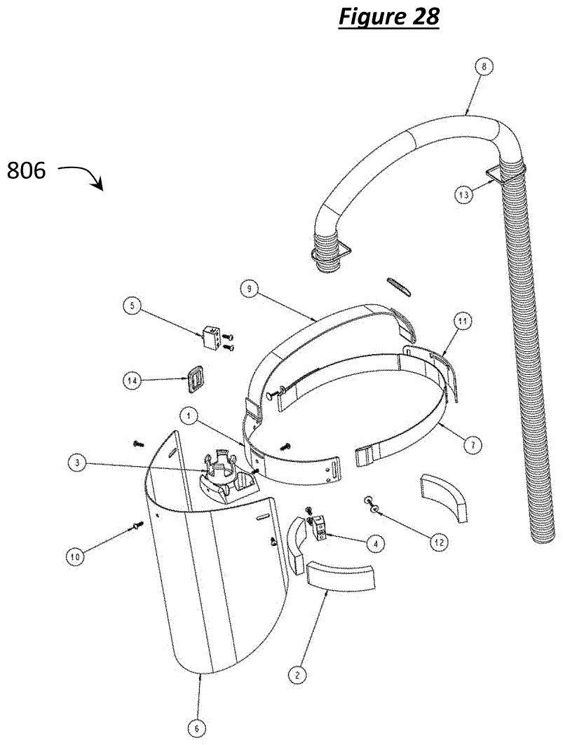

Referring collectively to FIG. 27 and FIG. 28, a further example visor portion assembly 806 is also configured having a multi-piece construction. An attachment port may be formed separately from, then assembled to, a front segment of the visor portion assembly 806. This configuration may allow for greater flexibility in the selection of differing materials between the inlet port and the front segment of the visor portion assembly 806.

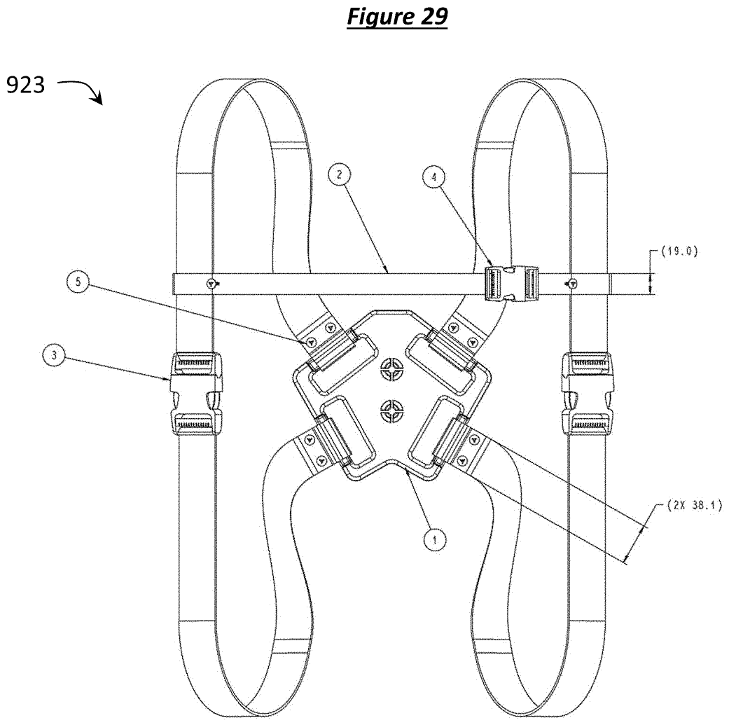

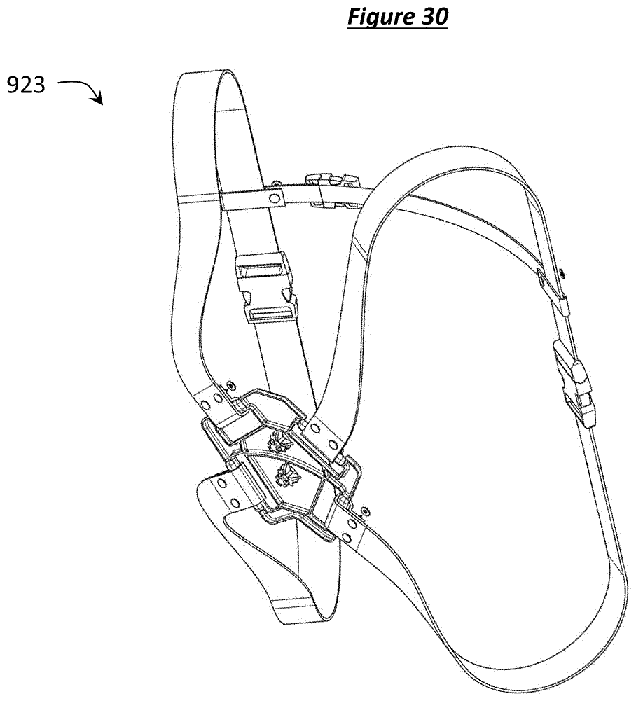

Referring collectively to FIG. 29 and FIG. 30, a harness assembly 923 includes a plurality of straps to retain a fan module to a user's body. In this example, a left primary strap and a right primary strap are routed through a lumbar support plate. Each of the primary straps is arranged to route over opposing shoulders of a user in a backpack configuration. A secondary strap may also be provided to extend laterally across a user's chest to secure the left primary strap to the right primary strap. A plurality of adjustment buckles may also be provided to adjust the length of the primary straps and thus the fit of the harness assembly to a user's torso. The buckles may further be provided with quick release features to allow a user to easily install and remove the personal air purifying system.

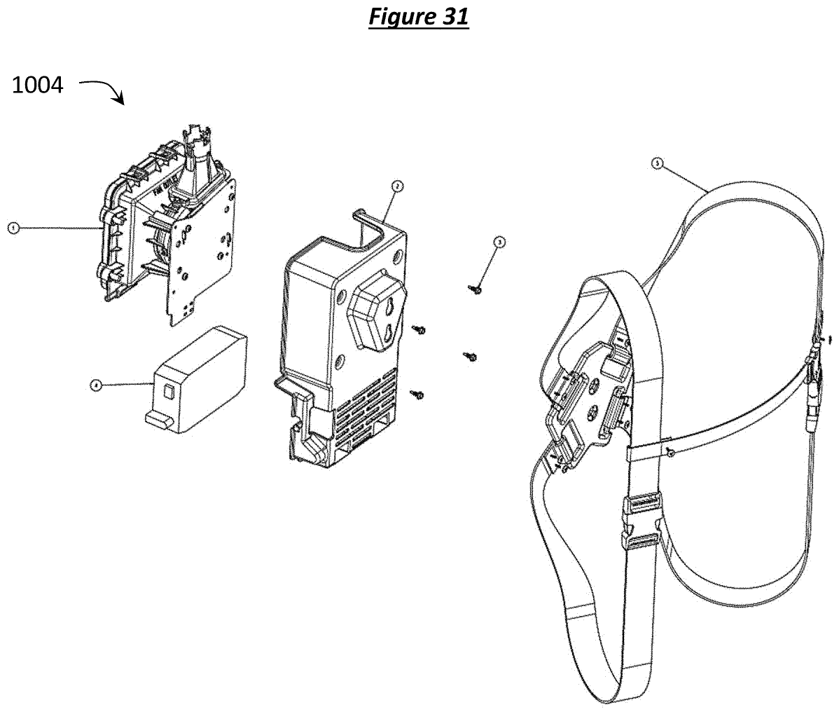

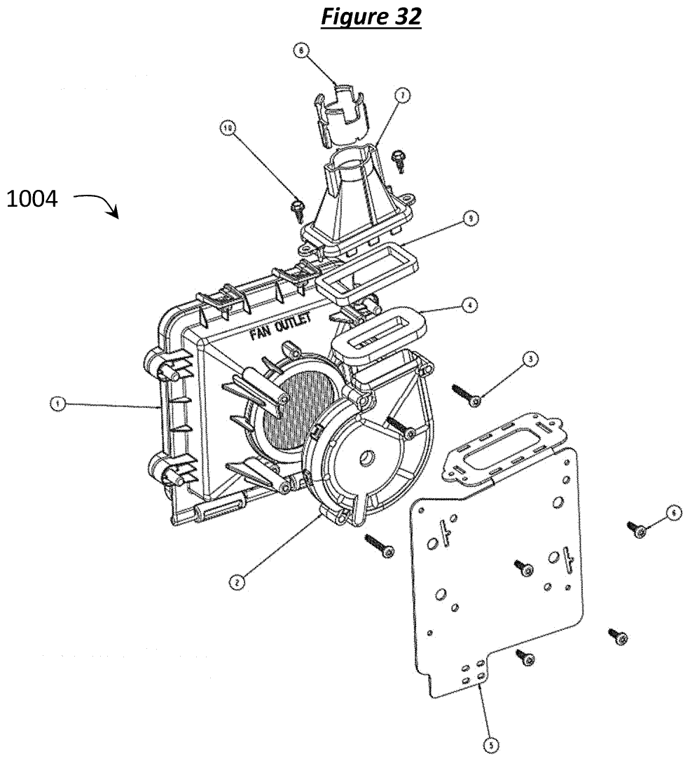

Rereferring collectively to FIG. 31 and FIG. 32, a PAPR air delivery subsystem 1004 is depicted in partial views. The air delivery subsystem 1004 includes a fan module is configured to attach to a lumbar support plate of a harness assembly. The fan module includes a removable battery to power an internal fan. A housing is provided having mounting features arranged to cooperate with the lumbar support plate. The housing is also configured to receive an air inlet cartridge having an air filter. In this example a battery mounting tray is integrally formed with the housing and includes features to retain the removable battery. The housing may further include vent portions to allow dissipation of heat generated by the removable battery.

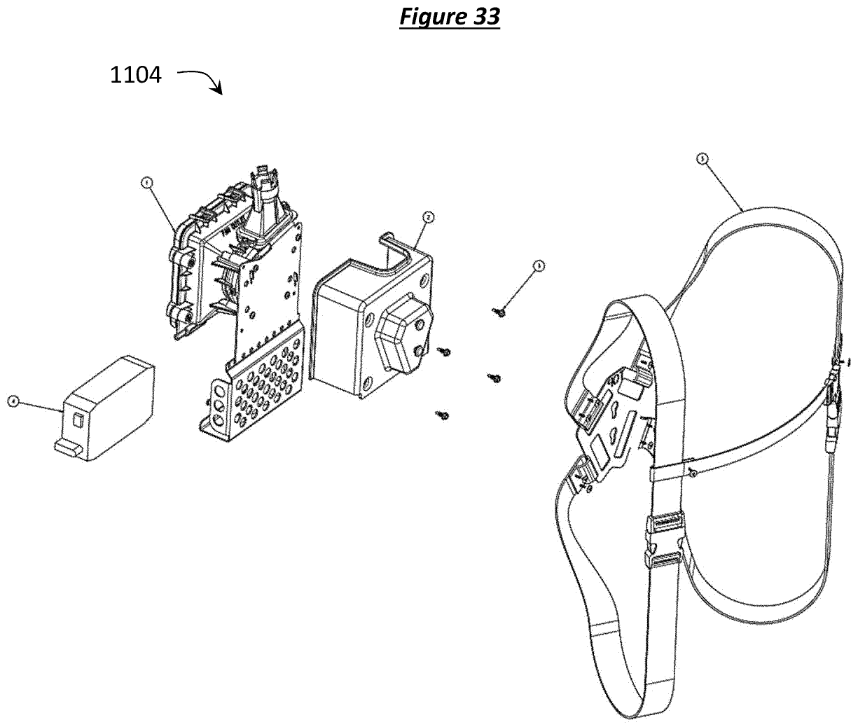

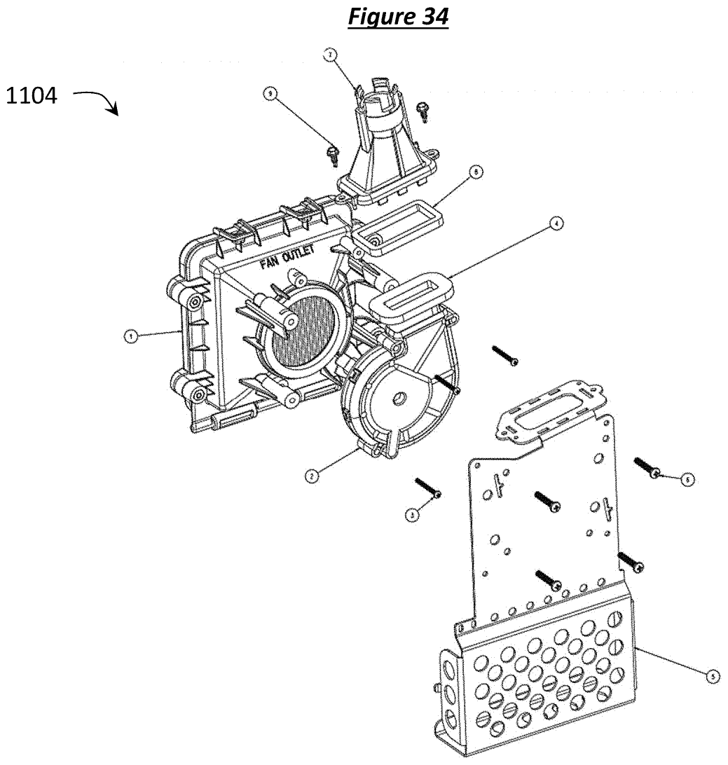

Referring collectively to FIG. 33 and FIG. 34, a further alternative example PAPR air delivery subsystem 1104 is depicted in partial views. The housing is also arranged to receive a battery mounting tray to secure the removable battery. In this example a battery tray is mounted to a fan mounting bracket. A controller may also be secured to the fan mounting bracket. The controller may then be conveniently pre-assembled and powered up by the battery to undergo functional testing prior to assembly of the remaining portions of the air delivery subsystem 1104.

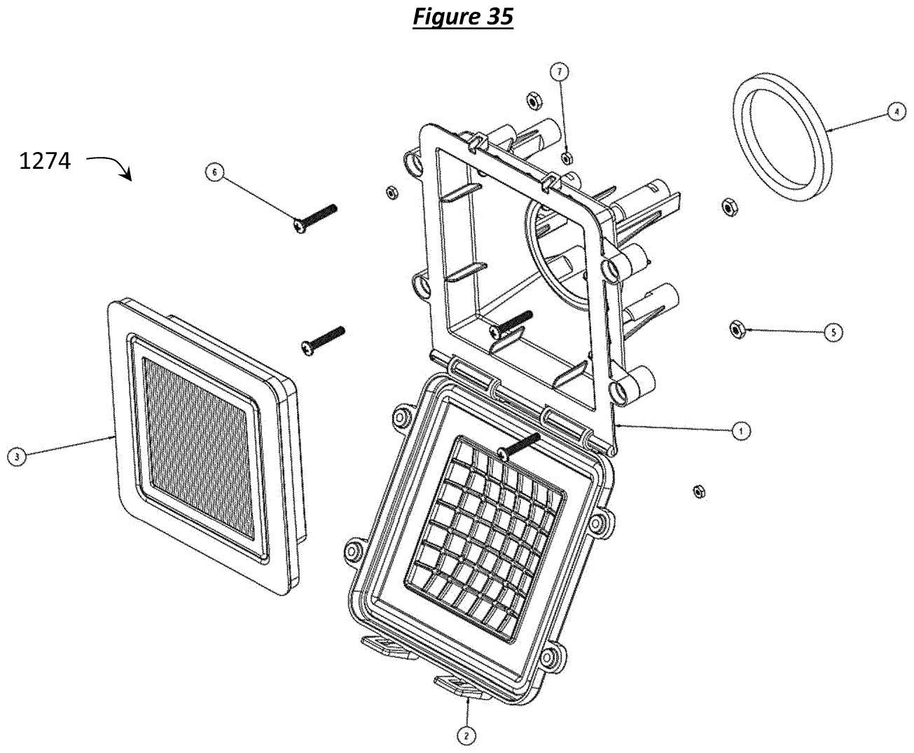

Referring to FIG. 35, an air cartridge assembly 1274 is depicted in an exploded view. The air cartridge assembly 1274 includes a housing portion having an air inlet grate to receive airflow from the external environment. The housing portion may be formed from a thermoplastic material and include mating half portions that define a sealed perimeter once clamped together. The half portions are hingedly connected to each other to define a clam shell configuration. When the clam shell is in an open first position, an air filter is in inserted into an internal cavity. Once rotated to a closed position, the housing creates a perimeter seal to about the air filter such that air is not allowed around a frame of the filter, but is instead forced to pass through the filtration elements of the air filter.

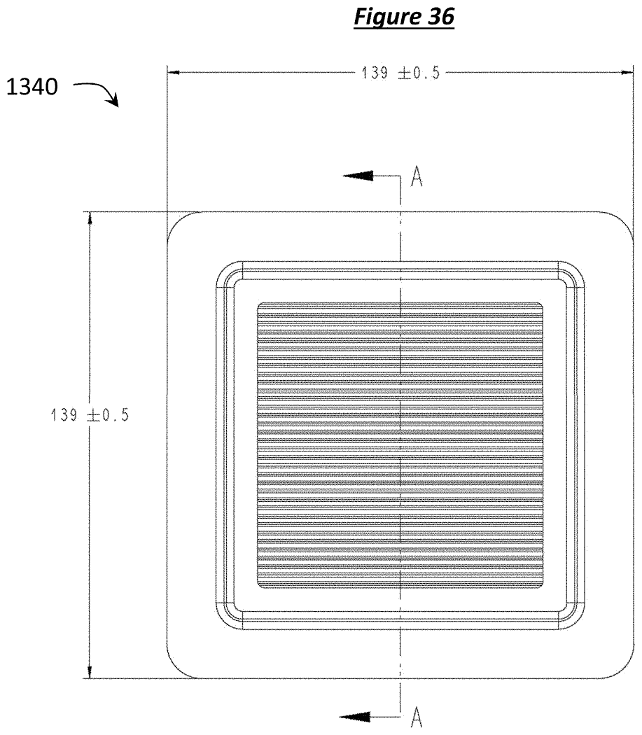

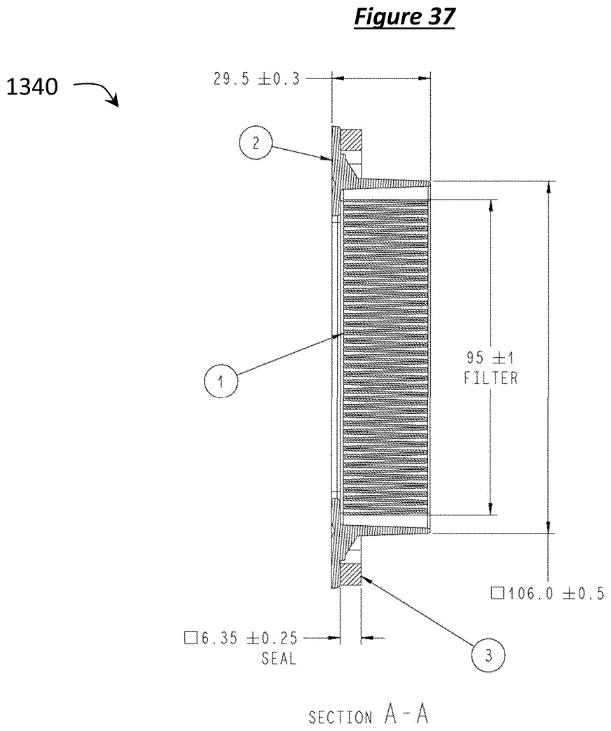

Referring collectively to FIG. 36 and FIG. 37, an air filter 1340 is depicted. A plurality of fibrous filtration elements may be provided to remove particulates from air passing therethrough. The air filter may also include a perimeter seal arranged to interface with a housing of an air filter housing assembly as discussed above. The air filter may be further configured to be disposable to facilitate easy replacement.

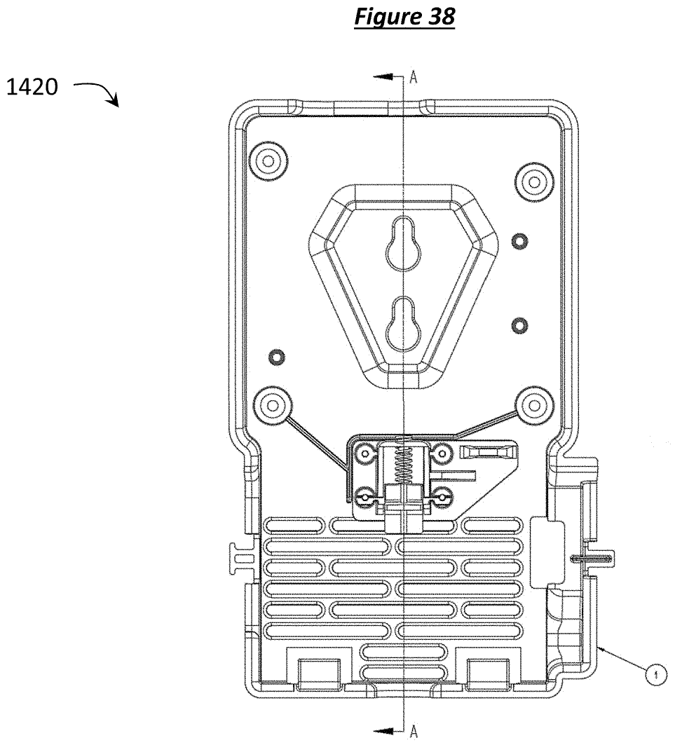

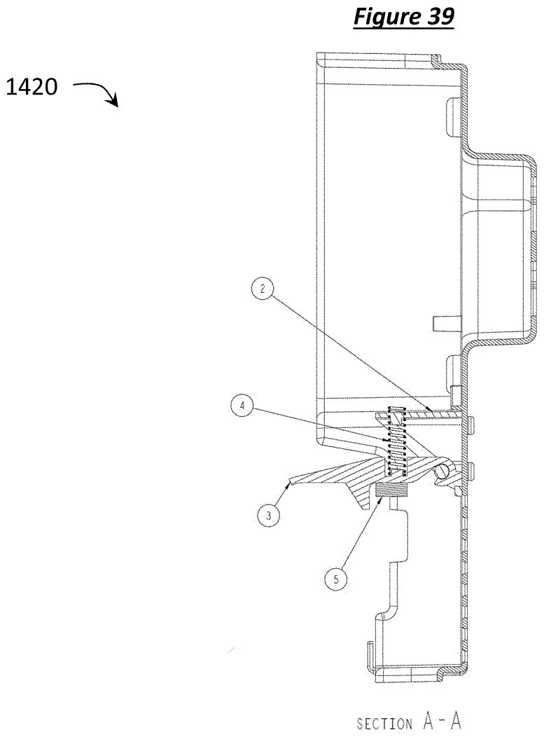

Referring collectively to FIG. 38 and FIG. 39, a fan assembly housing portion 1420 includes mounting features configured to cooperate with corresponding features on a lumbar support plate. The fan assembly is preferably sealed and if the fan construction utilizes multiple pieces, it may be preferable to add a gasket or seal between the pieces to limit or prevent air flow between the pieces. Similar to examples discussed above, the housing portion 1420 also includes an integral battery tray formed therein. The housing portion 1420 also include releasable retaining features adapted to lockingly engage features of a battery pack. In some specific examples, a spring-loaded release tab is provided with a locking protrusion. The release tab is biased toward a locking position to retain the battery once inserted in the battery tray. A user may articulate the release tab away from the locking position to disengage the battery to allow for removal of the battery for charging, replacement, or other service.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An air purification system comprising:
a visor portion configured to secure to a head of a user and maintain a field of vision for the user;
an air delivery portion configured to draw in air from an external environment; and
a disposable barrier hood configured to cover at least the visor portion,
wherein the visor portion defines a breathing outlet to exhaust the drawn-in air in proximity to a breathing area for consumption by the user, and the disposable barrier hood fluidly isolates the breathing area from the external environment.

2. The air purification system of claim 1, wherein the air delivery portion further comprises:
at least one filter to remove particulates from the drawn-in air to provide filtered air; and
a housing having an intake to receive the drawn-in air from the external environment and an outlet to exhaust the filtered air.

3. The air purification system of claim 2, wherein the air delivery portion further comprises a powered fan to urge the drawn-in air through the housing.

4. The air purification system of claim 3, wherein the air delivery portion further comprises a rechargeable power source to power the fan.

5. The air purification system of claim 4, wherein the air delivery portion further comprises a time estimation feature to calculate remaining power of the rechargeable power source and provide output to the user indicative of remaining time of operation available.

6. The air purification system of claim 1, wherein the air delivery portion includes a user interface portion including a control to allow the user to increase or decrease airflow output.

7. The air purification system of claim 1, wherein the air delivery portion includes an air delivery pipe providing for fluid communication of filtered air between the air delivery portion and the visor portion, wherein the disposable barrier hood is configured to cover at least a portion of the air delivery pipe.

8. The air purification system of claim 7, wherein the air delivery pipe is routed upward from the visor portion, above the head of the user, and behind the user to reduce inhibition of movement of the user.

9. The air purification system of claim 1, wherein the air delivery portion is mounted to the top of the visor portion.

10. The air purification system of claim 1, further comprising a draw string for tightening around the barrier hood to secure the barrier hood about the visor portion.

11. The air purification system of claim 1, wherein the visor portion includes one or more flexible straps arranged to wrap around the head of a user to secure the visor portion in place relative to the user.

12. The air purification system of claim 1, wherein the visor portion includes a viewing frame to define the field of vision of the user, the viewing frame encasing a transparent rigid material in front of the head of the user.

13. The air purification system of claim 1, wherein the visor portion includes:
a pair of laterally opposing side straps arranged to provide retention pressure to respective opposing sides of a head of a user; and
a center strap arranged to extend over the top of the head, the center strap including a rear bracing portion to support the visor portion against the back of the head,
wherein the center strap and the pair of laterally opposing side straps are contoured to conform to a shape and size of the head and to flex through an elastic range of deformation so as to deflect to provide an opening larger than an undeflected opening of the visor portion.

14. The air purification system of claim 13, wherein the visor portion includes one or more cushion pads arranged on the inner side of the pair of laterally opposing side straps and the center strap to interface with the head.

15. The air purification system of claim 13, wherein the visor portion includes spacing tabs protruding outward from each of the laterally opposing side straps, the spacing tabs being adapted to create an air gap between sides of the head of the user and the disposable barrier hood as installed over the visor portion.

16. The air purification system of claim 13, wherein the visor portion includes a brim, wherein a shield retention feature is disposed on the brim to attach a face shield to the visor portion.

17. The air purification system of claim 1, wherein the visor portion includes a hingeable face shield to allow the face shield to pivot relative to a brim of the visor portion.

18. The air purification system of claim 1, wherein the air delivery portion includes a fan module adapted to be affixed to a back of the user by one or more securing straps.

19. A method of using an air purification system, comprising:
applying headgear to a head of a user, the headgear including a visor portion for securing to the head of the user and maintaining a field of vision for the user and an air delivery portion for drawing in air from an external environment, the visor portion defines a breathing outlet to exhaust drawn-in air in proximity to a breathing area for consumption by the user;
installing a barrier hood over the headgear, the barrier hood covering at least the visor portion when installed for fluidly isolates the breathing area from the external environment; and
activating the air delivery portion to urge the drawn-in air from the external environment through the breathing outlet.

20. The method of claim 19, further comprising:
unsecuring the barrier hood; and
discarding the barrier hood.
